(19) United States
(12) Patent Application Publication
(10) Pub. No.: US 2024/0310321 A1
(43) Pub. Date: Sep. 19, 2024

(54) DIFFERENTIAL PMOS ISFET-BASED PH SENSOR

(71) Applicant: The Research Foundation for The State University of New York, Amherst, NY (US)

(72) Inventors: Albert TITUS, Buffalo, NY (US); Vaishak PRATHAP, Tonawanda, NY (US); Alexander VILLALTA, Tonawanda, NY (US)

(21) Appl. No.: 18/575,877

(22) PCT Filed: Jul. 1, 2022
(86) PCT No.: PCT/US2022/073398

§ 371 Date: Jan. 1, 2024

Related U.S. Application Data
(60) Provisional application No. 63/217,657, filed on Jul. 1, 2021.

(51) Int. Cl. G01N 27/414; G01N 27/416

(52) U.S. Cl. CPC G01N 27/4148; G01N 27/4167

(57) ABSTRACT

A pHI sensor system, Integrated Circuit (IC) chip, and a method are provided. Embodiments of the pH sensor may a first p-channel ion-sensitive transistor (IST)-operational-transconductance-amplifier (PIOTA) and a second PIOTA. Each PIOTA may further include a p-channel IST, an n-channel load transistor having a source and drain, wherein each PIOTA may have a drain-to-source resistance different from each other. Each PIOTA may further include an operational-transconductance-amplifier (OTA). A differential sensor may be connected to the outputs of both PIOTAs, and an output from the differential sensor may indicate a change in pH. Each PIOTA may further have an n-type substrate, a potential of which may be varied to control sensitivity of pH change detection. The NMOS load transistors of one or both of the PIOTAs may be selected from a plurality of NMOS load transistors to enhance sensitivity.

### CROSS REFERENCE TO RELATED APPLICATION

This application claims priority to U.S. Provisional Application No. 63/217,657, filed on Jul. 1, 2021, the entire disclosure of which is incorporated herein by reference.

### TECHNICAL FIELD OF THE DISCLOSURE

The present disclosure relates to sensors and methods which detect pH.

### BACKGROUND OF THE DISCLOSURE

Solid state sensors are becoming increasingly popular in many applications, including medicine, biotechnology, biomedical diagnosis, medical therapy and chemical analysis, as well as environmental and industrial monitoring. The technological advancements of integrated circuits that make computers and cell phones smarter with each generation are now contributing to a new era of medical devices having lower cost, power, and size than previous generations. However, ISFET-based readout architectures are plagued by several non-idealities that prevent them from widespread use in commercial applications. There is a need for ISFET pH sensors that are small, lightweight, have a fast response, and have improved sensitivity. There is also a need for sensor designs that can be conveniently mass-produced without affecting production throughput. By integrating sensors with signal processing components in an integrated circuit (IC), or “chip,” very small sensors may be made. CMOS fabricating techniques have the advantage of offering potentially low-cost, small and lightweight devices that can be mass-produced.

### SUMMARY OF THE INVENTION

In an embodiment of the present disclosure, a system is provided for measuring a pH of a solution. In an embodiment, the system may have a differential pH sensor. The differential pH sensor may have a first p-channel ion-sensitive transistor (IST)-operational-transconductance-amplifier (PIOTA) and a second PIOTA. The first PIOTA includes a first p-channel IST disposed in a first n-type substrate region having a terminal configured to receive a first control voltage for controlling a sensitivity of the first p-channel IST, and a first n-channel load transistor having a source and a drain, wherein the first n-channel load transistor has a first drain-to-source resistance (R_{ds}), and wherein the drain of the first n-channel load resistor is electrically connected to a drain of the first p-channel IST. The second PIOTA includes a second p-channel IST disposed in a second n-type substrate region having a terminal configured to receive a second control voltage for controlling a sensitivity of the second p-channel IST, and a second n-channel load transistor having a source and a drain, and wherein the second n-channel load transistor has a second R_{ds} which is different from the first R_{ds}, and wherein the drain of the second n-channel load resistor is electrically connected to a drain of the second p-channel IST. The differential pH sensor may further have a differential sensor with a differential sensor output configured to provide a voltage indicative of a difference in potential between an output of the first PIOTA and an output of the second PIOTA.

In some embodiments of the present disclosure, the system may further include one or more additional n-type substrate regions corresponding to one or more additional p-channel ISTs and the potential of each n-type substrate region is varied independently. The one or more additional n-type substrate regions may be configured in a common p-type substrate.

In some embodiments of the present disclosure, the first PIOTA, the second PIOTA, or both, of the system provided, may further have a plurality of selectable n-channel transistors with different R_{ds} from which at least one of the first and second n-channel load transistors may be selected respectively.

In some embodiments of the present disclosure, the first PIOTA may further include an amplifier wherein the input of the amplifier is electrically connected to the drain of the first p-channel IST and drain of the first n-channel load transistor, and wherein an output of the amplifier is the first PIOTA output.

In some embodiments of the present disclosure, the second PIOTA may further include an amplifier wherein the input of the amplifier is electrically connected to the drain of the second p-channel IST and the drain of the second n-channel load transistor, and wherein an output of the amplifier is the second PIOTA output.

In some embodiments of the present disclosure, the first PIOTA output is electrically connected to the gate of first n-channel load transistor, and the second PIOTA output is electrically connected to the gate of the second n-channel load transistor, in each case to control the R_{ds} of the respective n-channel load transistor.

In some embodiments of the present disclosure, a pH sensing method is provided. The method may include providing a sensor having a first ion-sensitive-transistor (IST)-operational-transconductance-amplifier (PIOTA) having: a first pH sensitive layer; a first PIOTA output; a first p-channel IST with a drain, and wherein the first p-channel IST is disposed in a first n-type substrate region; and a first n-channel load transistor including a source, a drain, and a channel, the channel electrically connecting the source and the drain, and wherein the first n-channel load transistor includes a first drain-to-source resistance (R_{ds}); wherein the drain of the first p-channel IST is electrically connected to the drain of the first n-channel load transistor; a second PIOTA having: a second pH sensitive layer; a second PIOTA output; a second p-channel IST with a drain, and wherein the second p-channel IST is disposed in a second n-type substrate region; and a second n-channel load transistor including a source, a drain and a channel, the channel electrically connecting the source and the drain, and wherein the second n-channel load transistor includes a second R_{ds}, and the second R_{ds} is different from the first R_{ds}; wherein the drain of the second p-channel IST is electrically connected to the drain of the second n-channel load transistor; a differential sensor having: a first input connected to the first PIOTA output; a second input connected to the second PIOTA output; and a differential sensor output wherein the differential sensor output may be configured to provide an indication of a voltage difference between the first input and the second input; placing the first pH sensitive layer and the second pH sensitive layer in contact with a substance; detecting a difference between first PIOTA output and second PIOTA output, and providing the difference to indicate a pH of the substance; and adjusting a potential of the first n-type substrate region and/or the second n-type substrate region to vary the sensitivity of the first PIOTA and/or the second PIOTA, respectively.

In some embodiments of the present disclosure, the method further includes wherein the first PIOTA has one or more additional n-channel load transistors, each having an R_{ds} which is different from the R_{ds} of the other n-channel load transistors. The method may further include selecting a different n-channel load transistor to adjust a sensitivity of the first PIOTA.

In some embodiments of the present disclosure, an Integrated Circuit (IC) chip for pH sensing is provided. The IC chip may have a differential pH sensor. The differential pH sensor may include a first ion-sensitive transistor (IST)-operational-transconductance-amplifier (PIOTA) and a second PIOTA. The first PIOTA includes a first p-channel IST disposed in a first n-type substrate region having a terminal configured to receive a first control voltage for controlling a sensitivity of the first p-channel IST, and a first n-channel load transistor having a source and a drain, wherein the first n-channel load transistor has a first drain-to-source resistance (R_{ds}), and wherein the drain of the first n-channel load resistor is electrically connected to a drain of the first p-channel IST. The second PIOTA includes a second p-channel IST disposed in a second n-type substrate region having a terminal configured to receive a second control voltage for controlling a sensitivity of the second p-channel IST, and a second n-channel load transistor having a source and a drain, and wherein the second n-channel load transistor has a second R_{ds} which is different from the first R_{ds}, and wherein the drain of the second n-channel load resistor is electrically connected to a drain of the second p-channel IST.

The differential pH sensor may further include a differential sensor having a differential sensor output configured to provide a voltage indicative of a difference in potential between an output of the first PIOTA and an output of the second PIOTA.

In some embodiments of the present disclosure, the IC provided further includes a plurality of n-wells corresponding to a plurality of p-channel ISTs, wherein the plurality of n-wells are configured in a common p-type substrate and the potential of each n-well is varied independently.

In some embodiments of the present disclosure, at least one of the first and second PIOTA, of the IC provided further includes a plurality of selectable n-channel transistors with different Width/Length (W/L) ratio from which the first and second n-channel load transistors respectively may be selected, where W is a width of the channel region of the n-channel transistor and L is the length of the channel region of the n-channel transistor.

### DESCRIPTION OF THE DRAWINGS

For a fuller understanding of the nature and objects of the disclosure, reference should be made to the following detailed description taken in conjunction with the accompanying drawings.

FIG. 1 is a diagram of a differential pH sensor according to an embodiment of the present disclosure.

FIG. 2 is a schematic diagram of an embodiment of PIOTA1.

FIG. 3 is a schematic diagram of an embodiment of PIOTA2.

FIG. 4 is a block diagram and pin out of a P-ISFET pH sensor chip according to an embodiment of the present disclosure.

FIG. 5 is a microscopic image of an example P-ISFET based pH sensor chip.

FIG. 6 is a description of an example P-ISFET based pH sensor chip DIP Package Pin-Out.

FIG. 7 shows the test setup for the test embodiment of a P-ISFET Chip.

FIG. 8 shows the variation of Vout1 and Vout2 for various pH values using a test embodiment.

FIG. 9 shows the variation of Delta Vout for various pH values of a test embodiment.

FIG. 10 shows the variation of Vout1 for various W/L ratios of small NMOS loads of a test embodiment at a pH of 2.

FIG. 11 shows the variation of Delta Vout for various W/L ratios of small NMOS loads of a test embodiment at a pH of 2.

FIG. 12 shows the variation of Vout1 for various W/L ratios of small NMOS loads of a test embodiment at a pH of 13.

FIG. 13 shows a variation of Delta Vout for various W/L ratios of small NMOS loads of a test embodiment at a pH of 13.

FIG. 14 shows Delta Vout versus pH for different width/length (W/L) ratios of a test embodiment.

FIG. 15 shows the example chip response to pH values with a sensitivity of around 15 mV/pH.

FIG. 16 shows the sensitivity of an example pH sensor in the acidic range was 22.6 mV/pH.

FIG. 17 shows the sensitivity of the example pH sensor in the alkaline range was 9.1 mV/pH.

FIG. 18 shows where a substrate control voltage of 1 V demonstrated the best sensitivity of a test embodiment in the pH range of 2 to 4.

FIG. 19 shows where a substrate control voltage of 0 V demonstrated the best sensitivity of a test embodiment in the pH range of 4 to 7.

FIG. 20 shows where a substrate control voltage of 0.5 V demonstrated the best sensitivity of a test embodiment in the pH range of 7 to 10.

FIG. 21 shows where a substrate control voltage of 0 V demonstrated the best sensitivity of a test embodiment in the pH range of 10 to 14.

FIG. 22 shows a drift of the example P-ISFET chip was measured to be −2.6 μV/s and the graph shows the successful application of substrate control voltage, V_{BS}=0.02 V to nullify drift.

FIG. 23 is a graph showing the approximate range through which output voltage could be adjusted to counter drift using the substrate control voltage adjustment knob of a test embodiment when V_{B} was fixed at 4 V.

FIG. 24 is a graph showing the approximate range through which output voltage could be adjusted to counter drift using the substrate control voltage adjustment knob of a test embodiment when V_{B} was fixed at 5 V.

FIG. 25 demonstrates the robustness of the pH sensor chip in measuring the pH of corrosive fluids such as salt solution, and further shows the sensitivity of a test embodiment of a chip for blood pH measurement was 79 mV/pH.

FIG. 26 shows the results of a test verifying the simulation result that the use of a smaller W/L ratio of 7.62 instead of 13.33 for the small NMOS load results in a sensitivity amplification of around 2.2×.

FIG. 27 is a schematic of an example P-ISFET based Pixel Array Chip.

FIG. 28 shows a microscopic image of the P-ISFET based Pixel Array Chip of FIG. 27 wire bonded to a PGA package.

FIG. 29 shows that the example P-ISFET based Pixel Array Chip was responsive to change in pH values with a sensitivity of around 25 mV/pH.

FIG. 30 demonstrates a multiple sensitivity capability of the example Pixel Array Chip

FIG. 31 shows Delta Vout vs Temperature for Normal, Medium, and Higher Sensitivity Pixels of the example P-ISFET based Pixel Array Chip demonstrating better temperature (non-ideality) rejection at higher width of small load at the expense of better sensitivity.

FIG. 32 shows drift of the example P-ISFET based Pixel Array Chip (0.3 mV/min) and the successful application of substrate control voltage knob (V_{SB}=0.06V) to nullify drift.

FIG. 33 shows the approximate range through which output voltage of the example P-ISFET based Pixel Array Chip may be adjusted to counter offset and drift using the substrate control voltage adjustment knob.

FIG. 34 shows the normalized variation in output voltage in response to V_{SB} knob adjustment clearly demonstrating that up to 0.4 V of offset/drift may be corrected with the example embodiment.

FIG. 35 is a flow chart showing a method according to another embodiment of the present disclosure.

### DETAILED DESCRIPTION OF THE DISCLOSURE

The presently-disclosed ion-sensitive field-effect transistor (ISFET) addresses the need for a monolithic, inexpensive, portable, miniaturized, label free, robust method of pH sensing using an unmodified complementary metal-oxide-semiconductor (CMOS) fabrication process without any post processing to measure pH of liquids. The compatibility of this pH sensor with the unmodified CMOS process automatically helps in obtaining the aforementioned qualities together with advantages like mass production, fast response, and easy miniaturization through technology scaling.

The advantage of using a PMOS device as the ISFET lies in its ability to be located in its own n-well. Thus, the substrate voltage V_{sb} of the PMOS can be controlled without affecting the operation of other components on chip. This can be further used to alter Vₜₕ in ways to change its sensitivity to AMs (pH), or to change the response of the ISFET in other ways. The present design is based on an ISFET previously-disclosed in U.S. Pat. No. 7,794,584, which is incorporated herein in its entirety by this reference, but improves on the previous design by using PMOS transistors (p-type or PFETs) as the ISFET. The PMOS transistors are disposed in n-wells, which provides improved noise performance, and facilitates variation of the well voltage of the PMOS which can alter the threshold voltage Vₜₕ. The option of giving a separate voltage to the bulk of the P-ISFET to improve the sensitivity of pH measurement was proven in the simulation results. To the best of knowledge of the inventors, this is the first design to use this approach to alter the ISFET operation as described above.

An advantage of the current pH sensor is the ability to fabricate it in a commercial CMOS process without any specialized post-fabrication processing. This provides several advantages for developing a low-power, low-cost, disposable sensor that can be easily mass-produced. This also provides the ability to develop sensors and signal processing and calibration circuits on a single CMOS IC. The modifications (self-calibration and use of the gold bonding wire) improve performance, simplify the system fabrication and reduce size. This improved design provides an electrically-controllable method for improving sensitivity of the ISFET. It builds on an existing differential design.

ISFET operation is based on the ability of the pH (H+ concentration) of a substance to alter the surface potential of the MOSFET (PMOS or NMOS), which is seen as an equal shift in the ISFET threshold voltage, Vₜₕ. The threshold voltage, Vₜₕ of the ISFET, similar to a standard MOSFET, is given by:

$${V}_{th} = {φ}_{MS} - 2 {φ}_{F} - \frac{{Q}_{dep}}{{C}_{ox}} + γ [ \sqrt{\vert - 2 {φ}_{F} + {V}_{SB} \vert} - \sqrt{\vert - 2 {φ}_{F} \vert} ] \qquad ( 1 )$$

The most relevant variables in this equation are φ_{MS}, which is the difference in the work functions of the polysilicon gate and the silicon substrate and is sensitive to the variation in the pH, and V_{SB}, which is the source-to-bulk (well) voltage. Thus, the response of the ISFET is determined by changes in Vₜₕ, and Vₜₕ can be changed by the pH (which changes φ_{MS}), or by V_{SB} (which is controllable electronically). By using a PMOS device, which is located in its own n-well, V_{SB} may be controlled without affecting the operation of other components on chip. Thus, this can be further used to alter Vₜₕ in ways to change its sensitivity to QMs (pH), or to change the response of the ISFET in other ways.

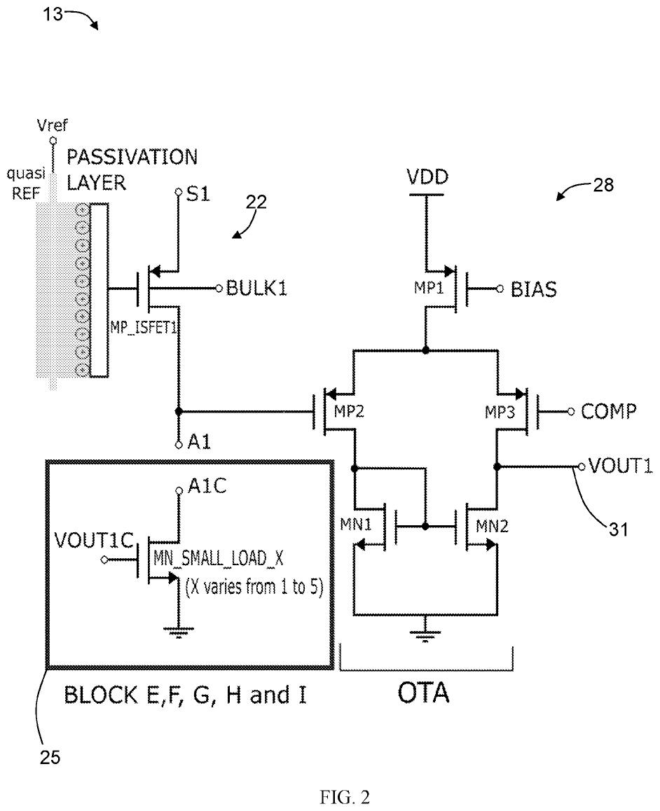

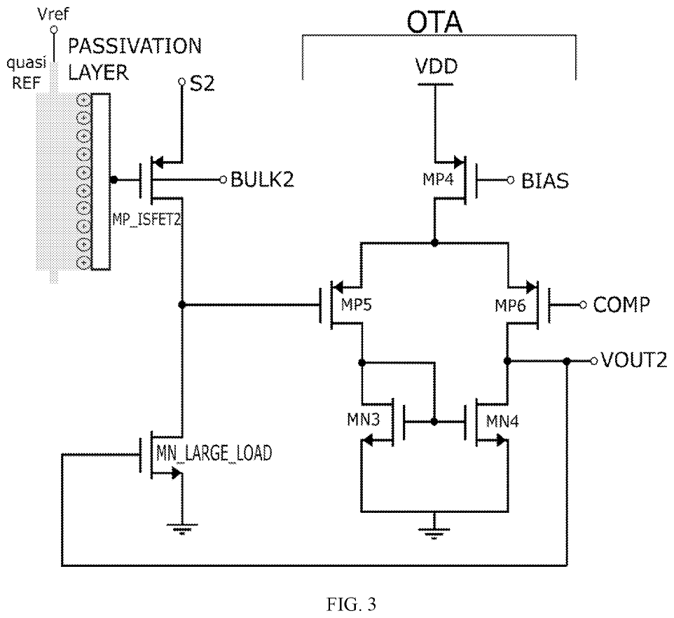

Embodiments of the present disclosure use a previously patented design, but improve on that design by using PMOS transistors (P-type or PFETs) with controllable well voltages as the ISFETs (see FIGS. 2 and 3). As appreciated by one of ordinary skill level in the art, in CMOS technology, common fabrication processes use a p-type material as the substrate. To fabricate an NMOS, the n-type source and drain terminals of the NMOS are directly fabricated on the common p-type substrate. However, for a PMOS, an individual n-well substrate is fabricated on the common p-type substrate, within which the p-type source and drain terminals are fabricated. Thus, the use of PMOS devices instead of NMOS devices provides for variation of the n-well voltage of the PMOS, which can alter the threshold voltage (Vₜₕ). The use of PMOS devices instead of an NMOS devices also provides improved noise performance. To the best of knowledge of the inventors, this is the first design to use this approach to alter the ISFET operation as described above.

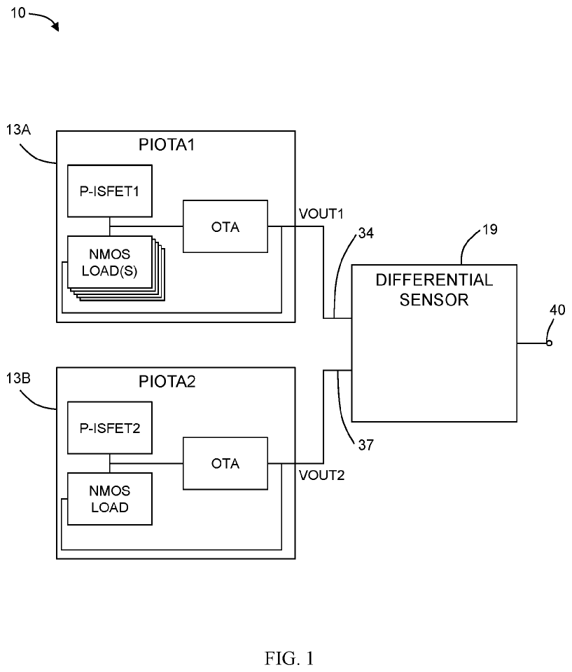

With reference to FIG. 1, the present disclosure may be embodied as a differential pH sensor 10 which can detect a change in pH. Such a pH sensor 10 may have a first p-channel ion-sensitive-transistor-operational-transconductance-amplifier (the “first PIOTA”) 13A, a second ion-sensitive-transistor-operational-transconductance-amplifier (the “second PIOTA”) 13B and a differential sensor 19.

In FIG. 2 there is shown a PIOTA 13, which includes a p-channel ion-sensitive transistor (an “IST” or “p-ISFET”) 22, which is electrically connected to an n-channel load transistor (the “load transistor”) 25. The IST 22 and the load transistor 25 may each be a field-effect transistor. The load transistor 25 may be a metal-oxide semiconductor field-effect transistor. The IST 22 has a drain, a source and a channel that electrically connects the drain and source regions of the IST 22. The IST is disposed in an n-type substrate region (an “n-well”) having a terminal configured to receive a control voltage (V_{SB}) for controlling a sensitivity of the IST (labeled “BULK1” in FIG. 3). The load transistor 25 has a source, a drain, and a channel that electrically connects the source and drain of the load transistor 25. The drain of the IST 22 is electrically connected to the drain of the load transistor 25.

In some embodiments, the sensor 10 may include a PIOTA having multiple n-mos load transistors to provide enhanced sensitivity by selecting a different load (or combination of loads). As a non-limiting example, FIGS. 1 and 2 show where the first PIOTA 13A of a sensor include five n-mos load transistors 25. In this way, the sensor may have improved pH-sensing sensitivity for different pH ranges. The first PIOTA, second PIOTA, or both may include one or more additional n-channel transistors, each having an R_{ds} which is different from the other n-channel transistors. The one or more additional n-channel transistors may be used alone or in combination with each other and/or the first or second n-channel load transistors to improve the differential sensitivity as explained below.

In some embodiments, the first PIOTA 13A of the sensor 10 may have one or more “small” NMOS loads (e.g., loads smaller than the load of the second PIOTA), and the second PIOTA 13B may have a “large” NMOS load (e.g., a load larger than the load of the first PIOTA). In this way, the small load produces a steep slope for VOUT1 compared to the large load on the other differential leg (PIOTA2) thereby helping to provide a better differential sensitivity for the chip towards pH.

The drains of the IST 22 and the load transistor 25 may be connected to an amplifier 28, which has an output 31 that may be considered the output for the PIOTA 13. In FIG. 3, the amplifier 28 includes n-MOSFETs MP1, MP2, and M3 as well as n-MOSFETs MN1 and MN2.

In this IOTA 13 design, a constant V_{DS} (drain-to-source voltage) may be maintained across the IST 22 by changing the I_{D} (drain current), which causes a change in the V_{DS} via the transconductance. This results in a change in the voltage of the drains. The drain voltage may be used as an input to the amplifier 28, compared with a fixed voltage (V_{comp}, labeled “COMP” in FIGS. 2 and 3), and the difference may be amplified to provide the output of IOTA 13. As shown in FIG. 2, the IOTA output 31 (VOUT1) may be provided as the feedback signal to the load transistor 25 (labeled “VOUT1C”), which again causes a change in the I_{D} such that the V_{DS} returns to its original value. Thus, a constant V_{DS} may be maintained.

Different n-type substrate region potentials may be used to improve pH sensitivity for different pH ranges. In some embodiments, one or more additional n-type substrate regions may be provided corresponding to one or more additional p-channel ISTs. The potential of each n-type substrate region may be varied independently (i.e., independent from one another). The one or more additional n-type substrate regions may be configured in a common p-type substrate. Selection of n-channel load transistors may be done independently from or together with varying the potential of the n-type substrate regions in order to improve pH sensitivity.

The ISTs 22 may employ a multilayer gate structure. The multilayer gate structure may have (1) an electrically-floating polysilicon layer, (2) two metal layers on top of the polysilicon layer, and (3) a silicon nitride (Si₃N₄) passivation layer on top of the metal layers.

The outputs 31 of the two IOTAs 13 are in communication with the differential sensor 19. The differential sensor 19 has a first input 34, a second input 37 and an output 40 (the “differential sensor output”). The differential sensor 19 may be a differential amplifier. The first input 34 of the differential sensor 19 is in communication with the first output 31 of the first IOTA 13A. The second input 37 of the differential sensor 19 is in communication with the second output 31 of the second IOTA 13B. The output 40 of the differential sensor 19 is used to provide an indication of a voltage difference between the differential sensor's 19 first input 34 and the differential sensor's 19 second input 37.

In an embodiment of the pH sensor, the load transistor 25 of the first IOTA 13A (the “first load transistor 25”) provides a drain-to-source resistance (the “first R_{ds}”), and the second load transistor 25 of the second IOTA 13B (the “second load transistor 25”) provides a drain-to-source resistance (the “second R_{ds}”), and the first R_{ds} is different from the second R_{ds}. In this manner, the first IOTA 13A will react differently from the second IOTA 13B to a pH. Therefore, if the first and second IOTAs 13A, 13B are sensing the same pH, their outputs 31 will be different, and the differential sensor 19 will detect the difference and provide an indication of the differing outputs from the IOTAs 13A, 13B.

To provide the differing drain-to-source resistances, the channel region of the first load transistor 25 may have a width that is different from a width of the channel region of the second load transistor 25. Further, the lengths of the channel regions of the load transistors 25 may be made different in order to provide the differing drain-to-source resistances, but doing so might also require matching the lengths of the channel regions of the ISTs 22 so that the load transistors 25 and their respective ISTs 22 are able to operate properly together. Since it may be preferable to use similar ISTs 22 in both IOTAs 13A, 13B, the lengths of the channel regions of both load transistors 25 may be similar, and in that situation the differing drain-to-source resistances may be provided by, for example, making the widths of the channel regions of the load transistors 25 different.

The ISTs 22 may each be an ion-sensitive field-effect transistor. The IST 22 of the first IOTA 13A (the “first IST 22”) and the IST 22 of the second IOTA 13B (the “second IST 22”) may be substantially similar. For example, they may be similarly sensitive to pH. The ISTs 22 may each include a pH-sensitive layer 43 (not shown). For example, the pH-sensitive layer 43 may be silicon nitride (Si₃N₄), silicon oxide (SiO₂), aluminum oxide (Al₂O₃), Titanium Pent-oxide (Ti₂O₅) and Tin Oxide (SnO₂). The pH-sensitive layer 43 may be electrically connected to the gate of the IST 22.

A pH sensor may use a gold or quasi gold reference electrode. The reference electrode provides a source of electrons which may be detected by the ISTs. The reference electrode may be placed on the same substrate as the IOTAs.

In an embodiment of the present disclosure, an Integrated Circuit (IC) chip is provided. The IC chip was designed focusing on a monolithic, inexpensive, portable, miniaturized, label free, robust method using an unmodified CMOS process without any post processing to measure pH of liquids such as blood. The compatibility of the pH sensor with the unmodified CMOS process helps in obtaining the aforementioned qualities together with advantages like mass production, fast response, and easy miniaturization through technology scaling.

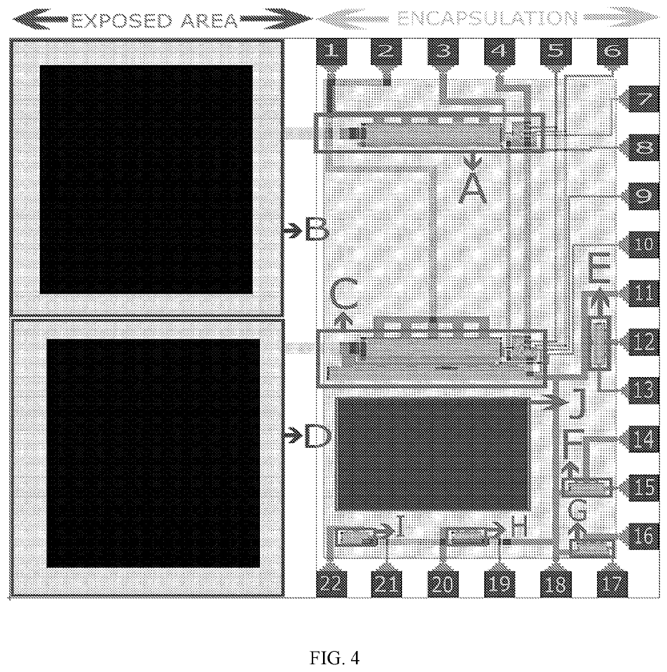

An exemplary chip layout according to an embodiment of the present disclosure is shown in FIG. 4. Several functional “blocks” are identified by letters in FIG. 4 and described below. The exemplary chip layout and description are intended to be illustrative and are not limiting. Other layouts, values, etc. are within the scope of the disclosure.
Block A: Block A includes one leg of the differential circuit and is termed as PIOTA1. It comprises three main components:
MP ISFET1: This is the first P-ISFET whose gate receives the surface potential developed on top of the Block B metal 4 layer.
MN_SMALL_LOAD_X: Blocks E to I are five small NMOS load transistors of P-ISFET1 of which drain of one of the NMOS load transistors is connected to the drain of P-ISFET1 and gate of one of the NMOS load transistors is connected to VOUT1. These loads are not part of Block A, but one of them is connected externally via the pads to the ISFET and the OTA (Operational Transconductance Amplifier) as specified above and they are mentioned here for understanding of the complete circuit diagram. The small load produces a steep slope for VOUT1 compared to the large NMOS load on the other differential leg thereby helping to provide a better differential sensitivity for the chip towards pH.
OTA: The single stage OTA includes the MOSFETS MP1, MP2, MP3, MN1, and MN2 (as shown in FIG. 2) in a differential configuration which amplifies the change in threshold voltage of the ISFET due to pH change and also provides feedback to the small NMOS load of the ISFET for providing constant drain current through the ISFET. BIAS and COMP signals given as input to the OTA ensure that all the transistors are kept in saturation and the amplification property of the OTA is maintained for the desired range of operation.

TABLE 1
Transistor Sizing in Block A

| Transistor Name | Width/Length (μm) |
|---|---|
| MP_ISFET1 | 405/40.5 |
| MP1 | 24/6 |
| MP2 | 6/6 |
| MP3 | 6/6 |
| MN1 | 24/6 |
| MN2 | 24/6 |

Block B: Block B is a rectangular block of metal 4 which is connected to the passivation layer exposed to the solution whose pH is to be measured. The surface potential developed by the pH of the solution on the passivation layer is conveyed on to this metal 4 block and subsequently to the gate of P-ISFET1 via metal 3, metal 2, and metal 1. A rectangular block of metal 3, metal 2, and metal 1, which is unconnected to any part of the chip, is made inside Block B to satisfy the DRC (design rule check) density criteria of all metal layers for this technology.
Block C: Block C includes the other leg of the differential circuit and is termed as PIOTA2. It comprises three main components:
MP ISFET2: This is the second P-ISFET the gate of which, receives the surface potential developed on top of the Block D metal 4 layer.
MN LARGE LOAD: This is the large NMOS load of P-ISFET2. The large load produces a less steep slope for VOUT2 compared to the small NMOS load on the other differential leg thereby helping to provide a better differential sensitivity for the chip towards pH.
OTA: The single stage OTA includes the MOSFETS MP4, MP5, MP6, MN3, and MN4 (as shown in FIG. 3) in a differential configuration which amplifies the change in threshold voltage of the ISFET due to pH change and also provides feedback to the large NMOS load of the ISFET for providing constant drain current through the ISFET. BIAS and COMP signals given as input to the OTA ensure that all the transistors are kept in saturation and the amplification property of the OTA is maintained for the desired range of operation.

TABLE 2
Transistor Sizing in Block C

| Transistor Name | Width/Length (μm) |
|---|---|
| MP_ISFET2 | 405/40.5 |
| MN_LARGE_LOAD | 600/10.5 |
| MP4 | 24/6 |
| MP5 | 6/6 |
| MP6 | 6/6 |
| MN3 | 24/6 |
| MN4 | 24/6 |

Block D: Block D is a rectangular block of metal 4 which is connected to the passivation layer exposed to the solution whose pH is to be measured. The surface potential developed by the pH of the solution on the passivation layer is conveyed to this metal 4 block and subsequently to the gate of ISFET2 via metal 3, metal 2, and metal 1. A rectangular block of metal 3, metal 2, and metal 1 which is unconnected to any part of the chip is made inside Block D to satisfy the DRC (design rule check) density criteria of all metal layers for this technology.
Block E: Block E is one of the five small NMOS loads among which drain of one of them will be connected to the drain of ISFET1 in Block A and gate will be connected to VOUT1 externally via pads. The smaller the load, better is the sensitivity slope of the PIOTA1 circuit which will help in obtaining a better differential sensitivity towards pH when differentially combined with the larger load of the PIOTA2 circuit. The size of MN_SMALL_LOAD_1 is chosen so as to compare the sensing abilities of this PMOS ISFET chip to the other twin NMOS ISFET chip because the exact same sized load is used in the NMOS ISFET chip as well. The Width/Length (W/L) of MN_SMALL_LOAD_1 is chosen to be 140/10.5 (μm).
Block F: Block F is one of the five small NMOS loads among which drain of one of them is connected to the drain of ISFET1 in Block A and gate will be connected to VOUT1 externally via pads. The W/L of MN_SMALL_LOAD_2 is chosen to be 100/10.5 (μm).
Block G: Block G is one of the five small NMOS loads among which drain of one of them is connected to the drain of ISFET1 in Block A and gate will be connected to VOUT1 externally via pads. The W/L of MN_SMALL_LOAD_3 is chosen to be 80/10.5 (μm).
Block H: Block His one of the five small NMOS loads among which drain of one of them is connected to the drain of ISFET1 in Block A and gate will be connected to VOUT1 externally via pads. The W/L of MN_SMALL_LOAD_4 is chosen to be 77/10.5 (μm).
Block I: Block I is one of the five small NMOS loads among which drain of one of them is connected to the drain of ISFET1 in Block A and gate will be connected to VOUT1 externally via pads. The W/L of MN_SMALL_LOAD_5 is chosen to be 75/10.5 (μm).
Block J: Block J comprises rectangular blocks of metal 4, metal 3, metal 2 and metal 1 which are unconnected to any part of the chip just to satisfy the DRC (design rule check) density criteria for all metal layers for this technology.

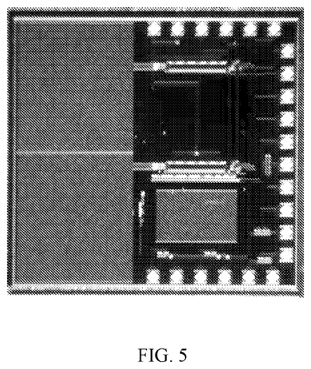

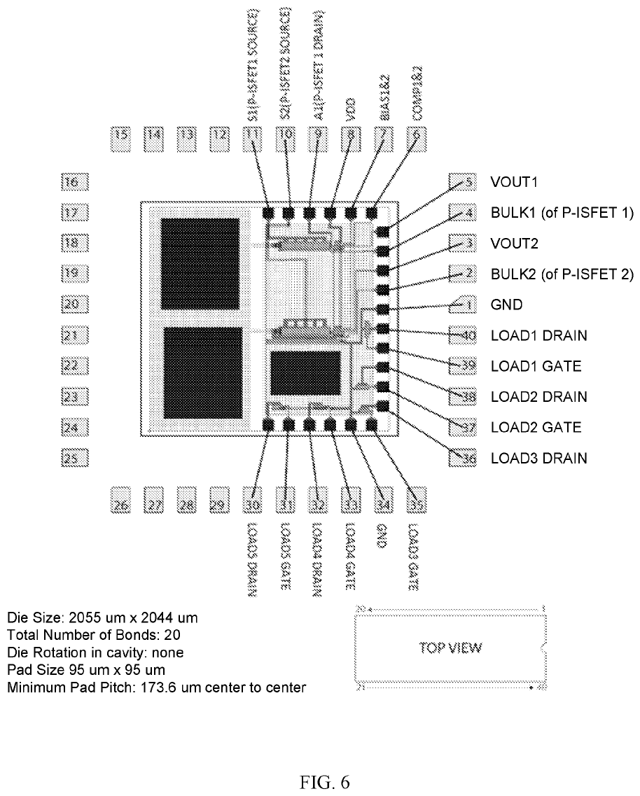

FIG. 5 provides a microscopic image of the P-ISFET based pH sensor chip. FIG. 6 provides a schematic of P-ISFET based pH sensor chip pin-out description which is summarized in the table below.

TABLE 3
P-ISFET based pH sensor chip DIP
Package Pin-Out Description

| | | Signal | | (Applied/ |
|---|---|---|---|---|
| Pin No. | Description | Range | | Received) |
| 1 | P-ISFET1 source. Notated as | 3-5 | V | Applied |
| | S1 in circuit diagram. | | | |
| 2 | P-ISFET2 source. Notated as | 3-5 | V | Applied |
| | S2 in circuit diagram. | | | |
| 3 | P-ISFET1 drain. Notated as | N.A. | | N.A. |
| | A1 in circuit diagram. | | | |
| 4 | VDD | 5 | V | Applied |
| 5 | BIAS | 2.5-3.8 | V | Applied |
| 6 | COMP | 0.1-3.3 | V | Applied |
| 7 | VOUT1 | 1-2.8 | V | Received |
| 8 | BULK1 | 3-5 | V | Applied |
| 9 | VOUT2 | 0.8-1.4 | V | Received |
| 10 | BULK2 | 3-5 | V | Applied |
| 11 | GND | 0 | V | Applied |
| 12 | MN_SMALL_LOAD_1 drain | N.A. | | N.A. |
| 13 | MN_SMALL_LOAD_1 gate | N.A. | | N.A. |
| 14 | MN_SMALL_LOAD_2 drain | N.A. | | N.A. |
| 15 | MN_SMALL_LOAD_2 gate | N.A. | | N.A. |
| 16 | MN_SMALL_LOAD_3 drain | N.A. | | N.A. |
| 17 | MN_SMALL_LOAD_3 gate | N.A. | | N.A. |
| 18 | GND | 0 | V | Applied |

| | | | |
|---|---|---|---|
| 19 | MN_SMALL_LOAD_4 gate | N.A. | N.A. |
| 20 | MN_SMALL_LOAD_4 drain | N.A. | N.A. |
| 21 | MN_SMALL_LOAD_5 gate | N.A. | N.A. |
| 22 | MN_SMALL_LOAD_5 drain | N.A. | N.A. |

The basic function of the differential PMOS ISFET (Ion-Sensitive Field-Effect Transistor) based pH sensor chip is to measure the pH of the solution to which it is exposed. In some embodiments, the sensor circuit comprises two differential legs named PIOTA1 and PIOTA2. A chip embodying the sensor circuit may utilize the inherent pH sensing capability of the silicon nitride passivation layer in the unmodified 0.35 μm CMOS process. The pads and the transistors of the chip are encapsulated with an epoxy coating such that only the extended gate region of the ISFET is exposed to the solution. When the chip is exposed to a solution having a certain pH value, the passivation layer develops a surface potential due to the development of amphoteric silanol sites and basic amine sites on the surface of the passivation layer. The surface potential developed in this way is proportional to the pH value of the solution. The potential of the solution is defined by the DC voltage applied through a quasi gold reference electrode immersed in the solution. The potential developed on the passivation layer is obtained by the two large rectangular blocks of metal 4 and transmitted to the gate of the two differential P-ISFETs (p-type ISFET) through the metal 3, metal 2, and metal 1 layers. Thus the surface potential is conveyed to the gate of the differential P-ISFETs and this process can be viewed as a modification of threshold voltage of the P-ISFETs. Since all the transistors have been biased to operate in saturation region, the current through the P-ISFET follows square law distribution as:

$${I}_{d} = \frac{1}{2} {u}_{p} {C}_{ox} \frac{W}{L} {( Vsg - Vth )}^{2} ( 1 + {λV}_{SD} ) \qquad ( 2 )$$

Thus, according to equation (2), the change in threshold voltage causes a change in drain current flowing through the ISFET which is converted to a voltage value by the OTA, and the feedback in the circuit ensures that constant I_{d} and V_{DS} are restored in the circuit. Thus the pH of the solution is converted into an analog voltage electrical output and by mapping the pH values to voltage through experimental results, the device can be calibrated to measure pH of the solution. The two legs of the differential circuit may be identical in all aspects except for the width of the NMOS load. The differently-sized loads result in different amplification factors for the same pH, and hence a differential sensitivity towards a particular pH without any post processing may be obtained which is a unique achievement. This differential measurement architecture also helps to reject common mode signals between two inputs, thereby minimizing the impact of non-ideal effects such as drift, noise, and temperature on the pH measurements. The differential design also help to eliminate the use of bulky and short life time problem associated with Ag/AgCl reference electrode, which is an enormous advantage as far as miniaturization and stability are concerned. Instead a quasi gold reference electrode common to both differential legs of the circuit is used.

PMOS ISFET is utilized for this sensor design keeping in mind the better noise performance of PMOS compared to NMOS, the use of PMOS in an n-well provides added protection against latch up and the option of giving a separate voltage to the bulk of the P-ISFET to elevate the sensitivity towards pH measurement which was proven in the simulation results.

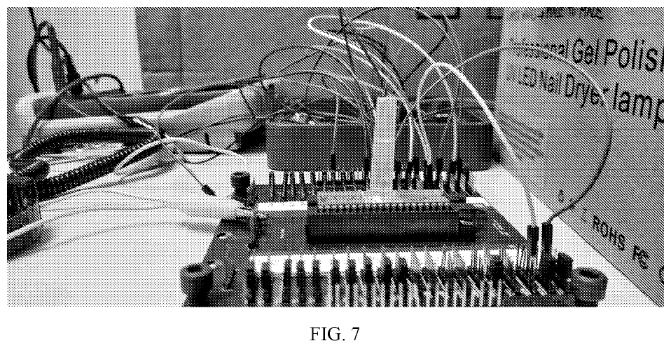

FIG. 7 provides a test setup for a P-ISFET chip. In another embodiment of the present disclosure, experiments were performed to characterize P-ISFET integrated circuit (chip #P7) to identify best value for each of the three bias voltages Vref, Vcomp and Vbias within their respective ranges of 0 V to 5 V inclusive, 2 V to 4 V inclusive and 3 V to 4 V inclusive, respectively. All data operations used VDD=5 V. 300 μl of a buffer solution having pH 6.8 was placed in contact with the P-ISFET chip (#P7). Two output voltages from the sensor (Vout1 and Vout2) were obtained for all permutations of Vref, Vbias, and Vcomp. Vout1 corresponds to the output of a first P-ISFET sensor element having smaller NMOS load than a second P-ISFET sensor element. Vout2 corresponds to the output of the second P-ISFET sensor element. The output used is the difference of Vout1 and Vout2:

$$ΔV out = V out 1 - V out 2$$

For these initial tests, ΔVout was provided with no additional amplification and no zero offset. The best values for the biasing voltages were obtained as Vref=0 V; Vcomp=3 V; and Vbias=3.6 V.

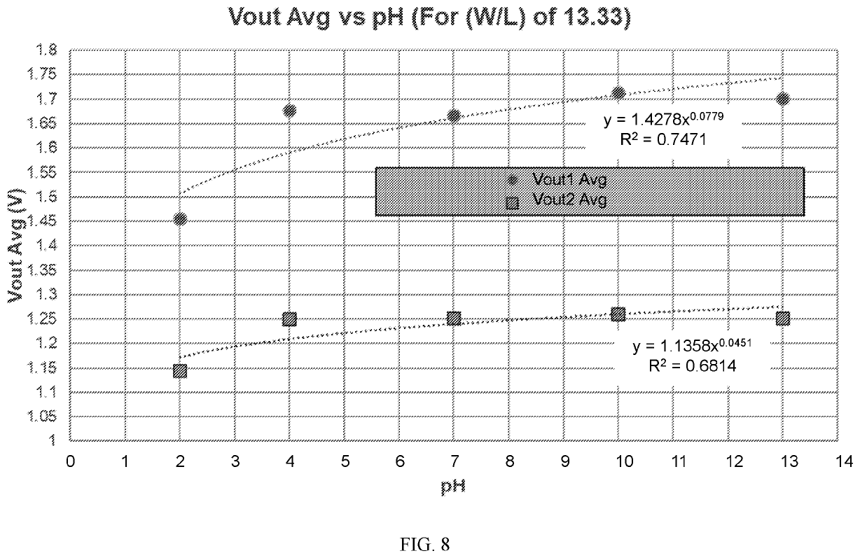

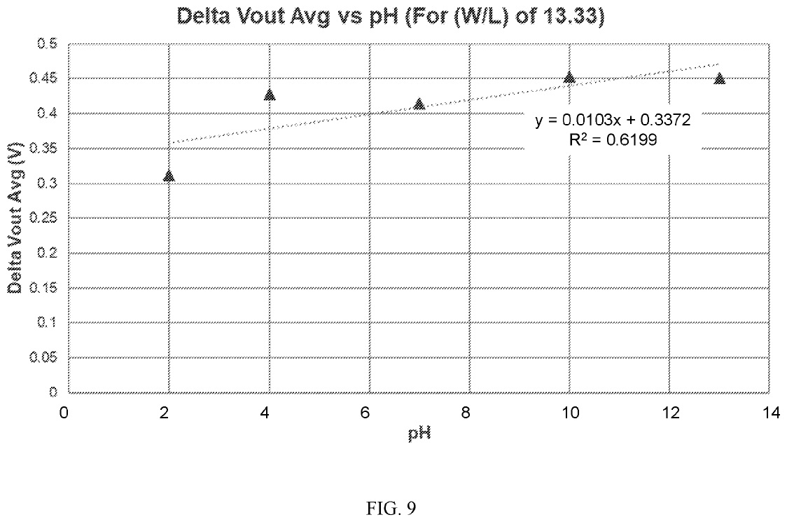

In another embodiment of the present disclosure, the P-ISFET Chip #P7 was tested to study its response to pH. Proper biasing voltages were given to the P-ISFET chip via an NI-USB 7845R data acquisition device (DAQ). All output and nodal voltages were acquired by the same DAQ using LabVIEW. An NMOS load having W/L ratio of 13.33 was used for the first P-ISFET sensor element. 600 μL of various solutions having pHs of 2, 4, 7, 10, and 13 were alternatively placed in contact with the chip and data was collected for each using the NI-USB DAQ device. Each pH solution was kept in contact with the chip for approximately 3 minutes and an average of the readings over those 3 minutes was taken to get output voltages Vout1 Avg, Vout2 Avg, and Delta Vout Avg. The results from the data collected are summarized in graphs FIG. 8 and FIG. 9.

FIG. 8 and FIG. 9 clearly demonstrate that the P-ISFET chip responded to pH change successfully as the output voltage varied with pH. As described earlier, Vout1 corresponds to the ISFET connected to the smaller NMOS load (having W/L=13.33) and Vout2 corresponds to the ISFET connected to the larger NMOS load (having W/L=57.14). The difference of Vout1 and Vout2 is taken to obtain Delta Vout so that a differential configuration setup may nullify the effects of temperature, noise, and other common mode non-idealities which can affect the output voltages if readings were taken in single ended configuration.

In another embodiment of the present disclosure, the P-ISFET chip was tested to study its response when using different NMOS loads present in the chip with a view to enhance sensitivity. There were five NMOS loads present in the circuit as shown in FIGS. 1-2.

TABLE 3
Five load sizes used on the chip.

| MN_SMALL_LOAD_X | W/L (μm) | Aspect ratio |
|---|---|---|
| MN_SMALL_LOAD_1 | 140/10.5 | 13.33 |
| MN_SMALL_LOAD_2 | 100/10.5 | 9.52 |
| MN_SMALL_LOAD_3 | 80/10.5 | 7.62 |
| MN_SMALL_LOAD_4 | 77/10.5 | 7.33 |
| MN_SMALL_LOAD_5 | 75/10.5 | 7.14 |

The inventors observed from simulations that for NMOS loads having smaller W/L ratio in first differential leg (corresponding to Vout1) of the circuit then the sensitivity of the pH sensor could be enhanced. Based on this, four other small NMOS Loads (other than the initial load having aspect ratio of 13.33) having different W/L ratios were studied to identify the best value to maintain equilibrium condition (saturation condition of all MOSFETs) of the circuit. Each of the five small NMOS loads were connected to the circuit individually and the data was collected for pH values of 2, 4, 7, 10, and 13.

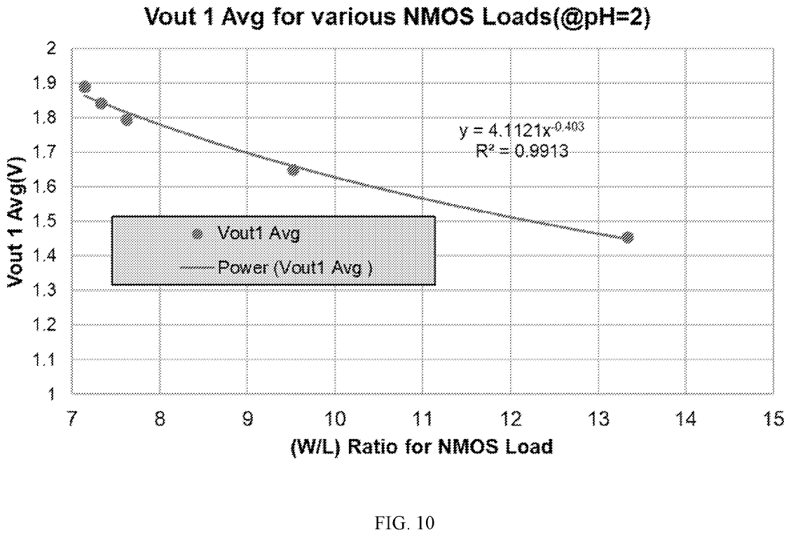

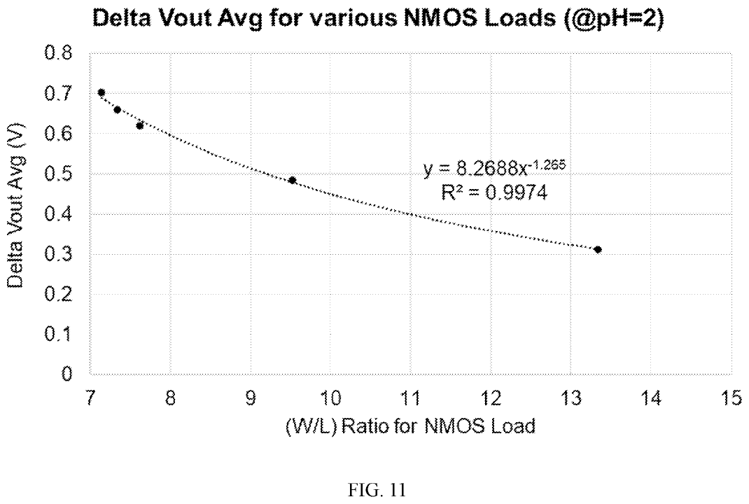

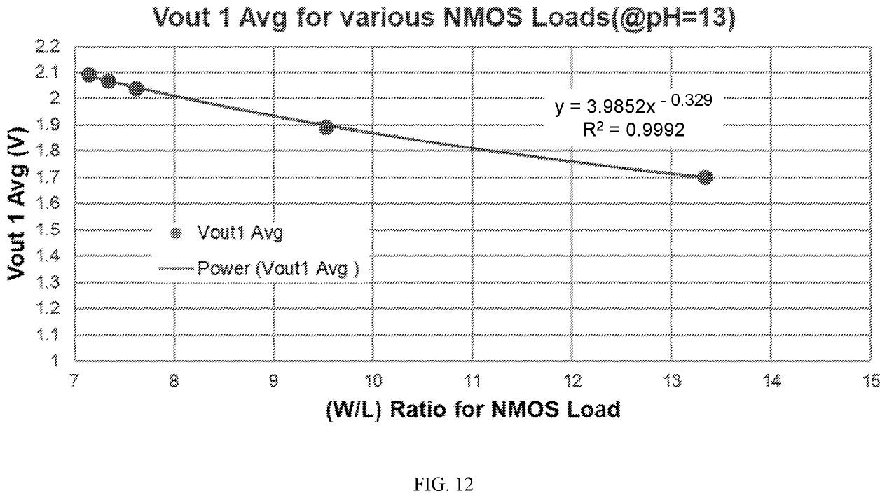

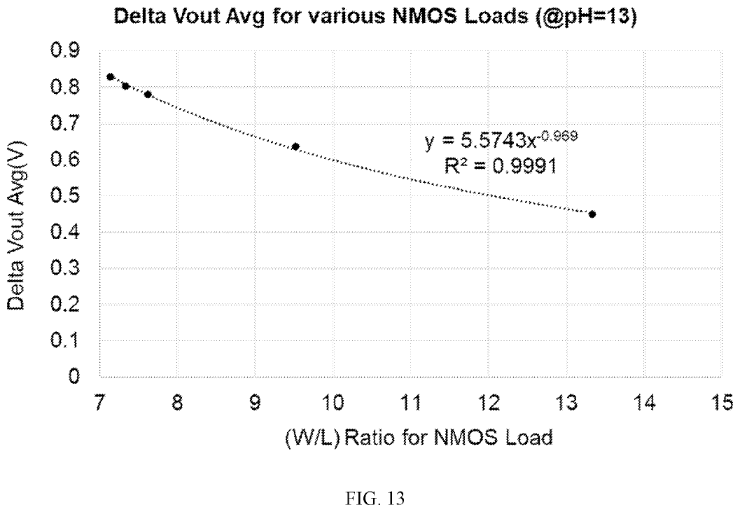

FIGS. 10 and 11 clearly demonstrate that Vout1 and correspondingly Delta Vout increase as the W/L ratio of the small NMOS load decrease for pH value of 2. This demonstrates that smaller W/L ratios of small NMOS loads yield higher Vout voltages, that is, better sensitivity. This experiment was repeated for pH values of 4, 7, 10, and 13 and all these experiments returned similar results for all pH values. The result obtained at pH 13 is provided in FIGS. 12 and 13. This demonstrates that the sensitivity enhancement achieved through varying small NMOS loads is valid across the entire pH range.

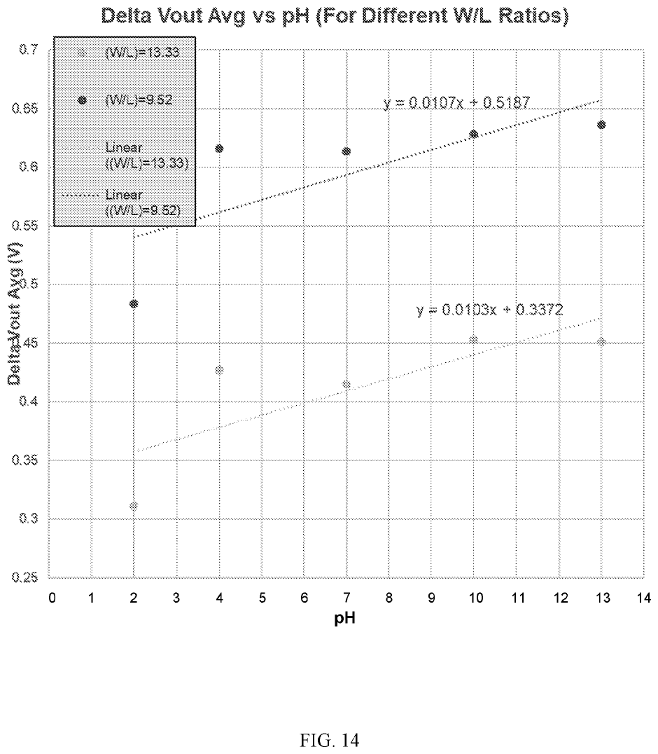

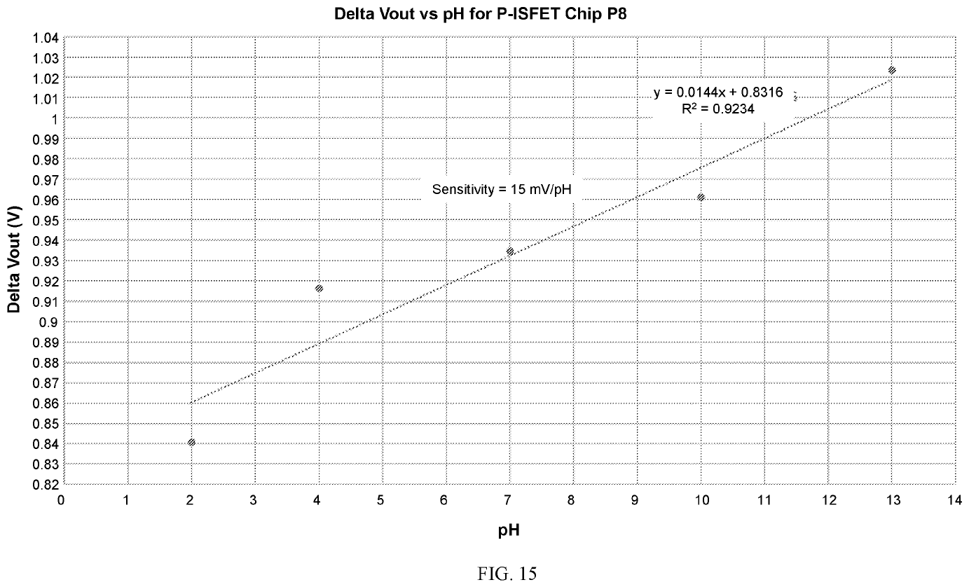

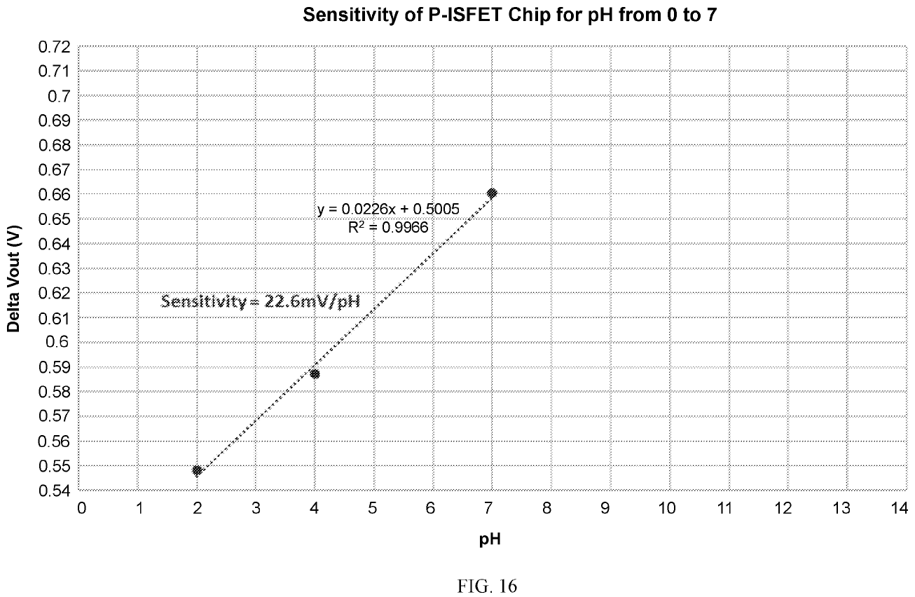

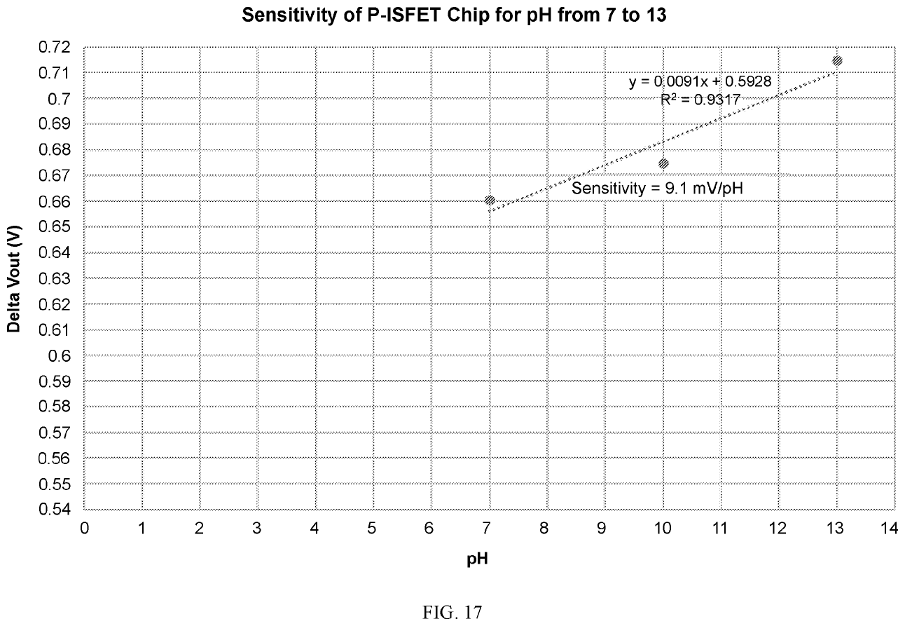

FIG. 14 further demonstrates the variation of output differential voltage Delta Vout to various pH solutions for two different aspect ratios of 13.33 and 9.52. It can be seen from the slope of the linear equation of the two aspect ratio graphs that the smaller W/L ratio of 9.52 has 1.04 times more sensitivity than the larger W/L ratio of 13.33. This demonstrates that the decreasing W/L ratio without disturbing the equilibrium condition of the circuit enhances sensitivity. FIG. 15 further demonstrates that the chip responds to pH changes with a sensitivity of 15 mV/pH across the entire pH range. For acidic and alkaline ranges shown in FIGS. 16 and 17, the chip responds to pH changes with a sensitivity of 22.6 mV/pH and 9.1 mV/pH respectively.

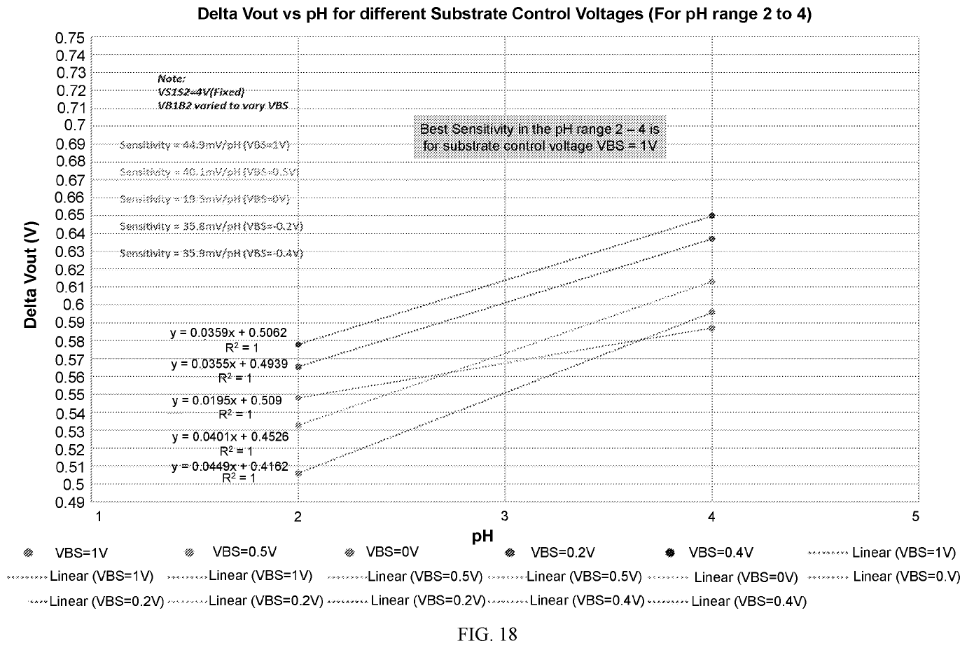

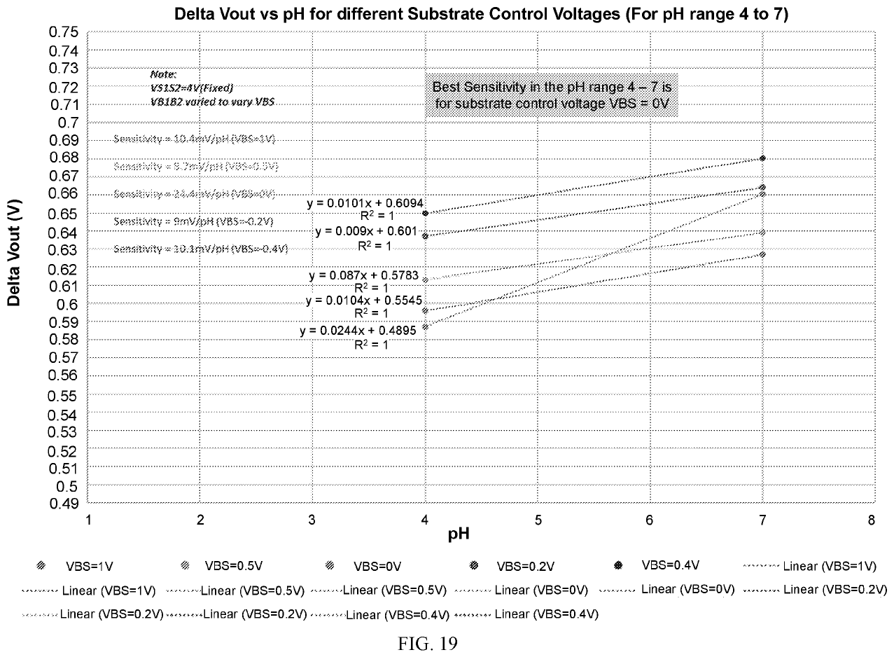

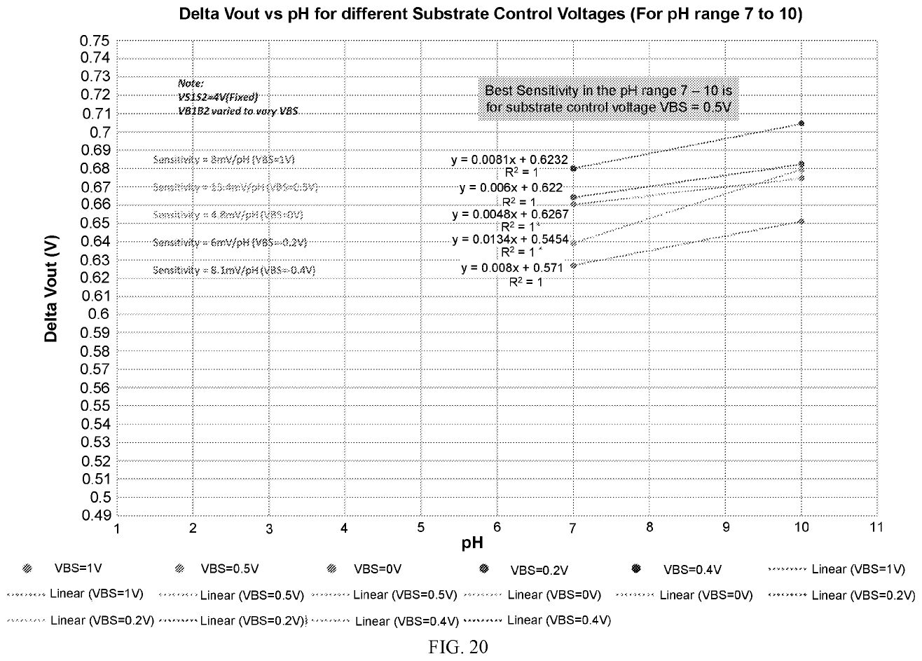

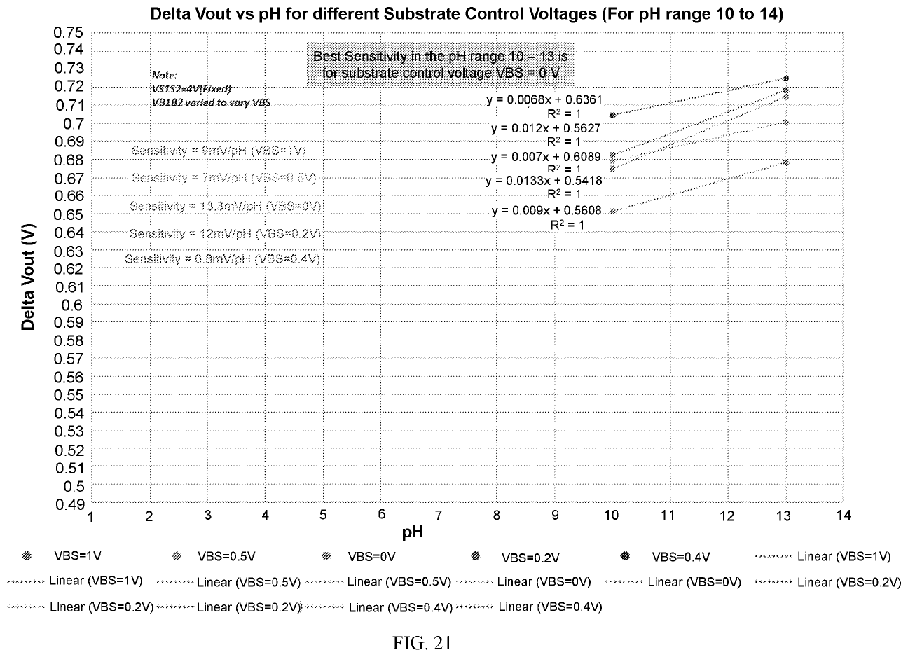

In another embodiment of the present disclosure, the p-ISFET chip was tested to study sensitivity enhancement through variation of substrate control voltage (V_{BS}). The source voltages of both P-ISFETS were fixed at 4 V. V_{BS} was varied and the output for the entire sensor element was taken as the difference of VOUT1 and VOUT2: ΔVout=VOUT1−VOUT2. The capacitive multiplication effect due to coherent application of the gate voltage and substrate control voltage should theoretically give rise to a boost in sensitivity. This was verified with simulations in the AMS 0.35 μm technology node. FIGS. 18-21 show results of testing for sensitivity enhancement by applying substrate control voltage (V_{BS}). FIG. 18 demonstrates that a V_{BS} of 1 V provides the best sensitivity in the pH range of 2 to 4. FIG. 19 demonstrates that a V_{BS} of 0 V provides the best sensitivity in the pH range of 4 to 7. FIG. 20 demonstrates that a V_{BS} of 0.5 V provides the best sensitivity in the pH range of 7 to 10. FIG. 21 demonstrates that a V_{BS} of 0 V provides the best sensitivity in the pH range of 10 to 14.

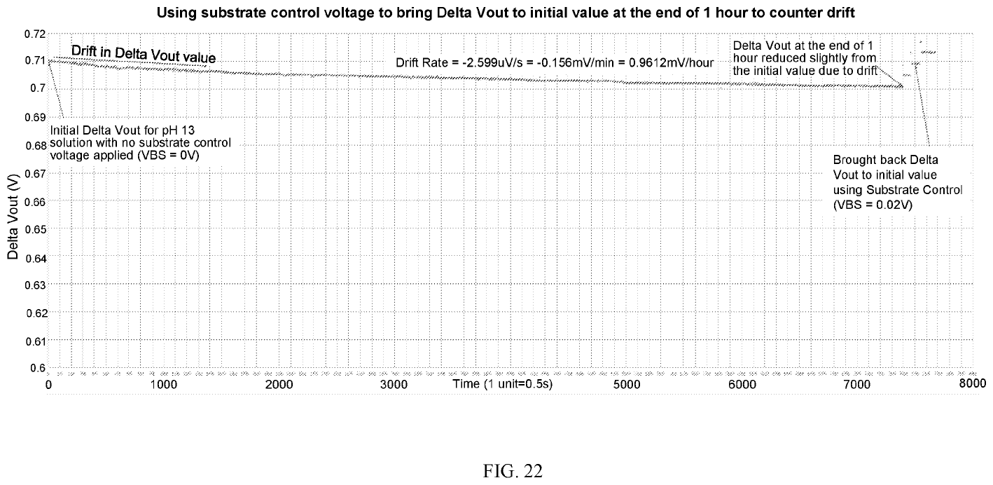

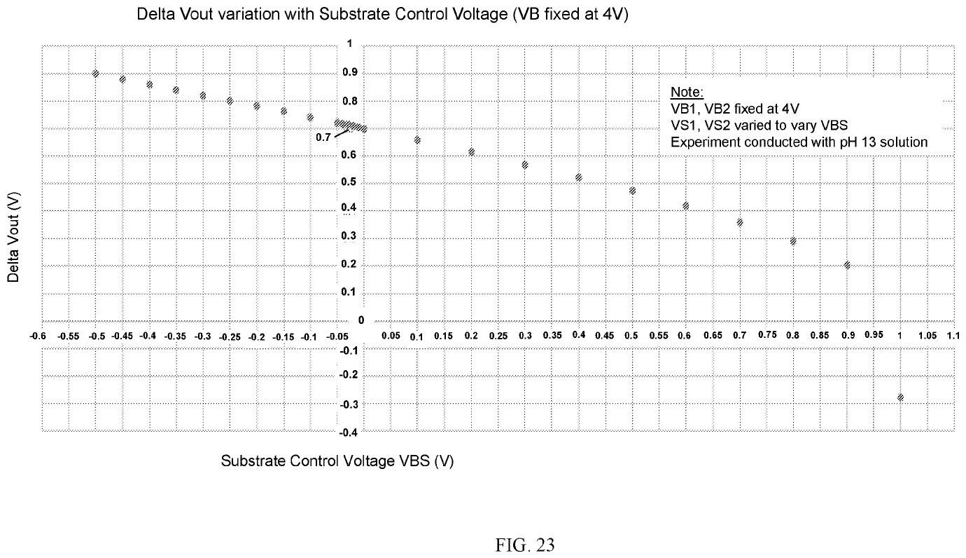

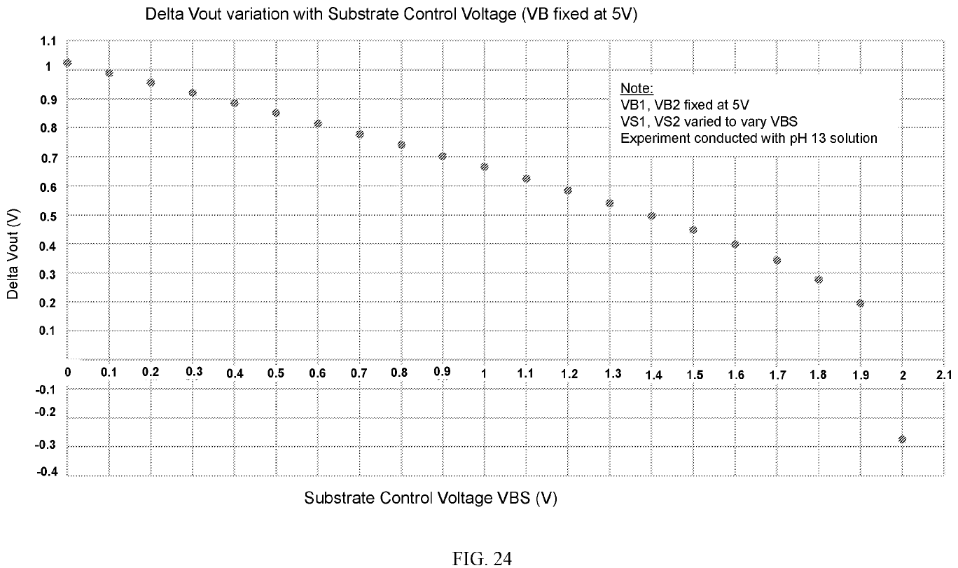

FIGS. 22-24 show computation of drift and using substrate control voltage to neutralize drive.

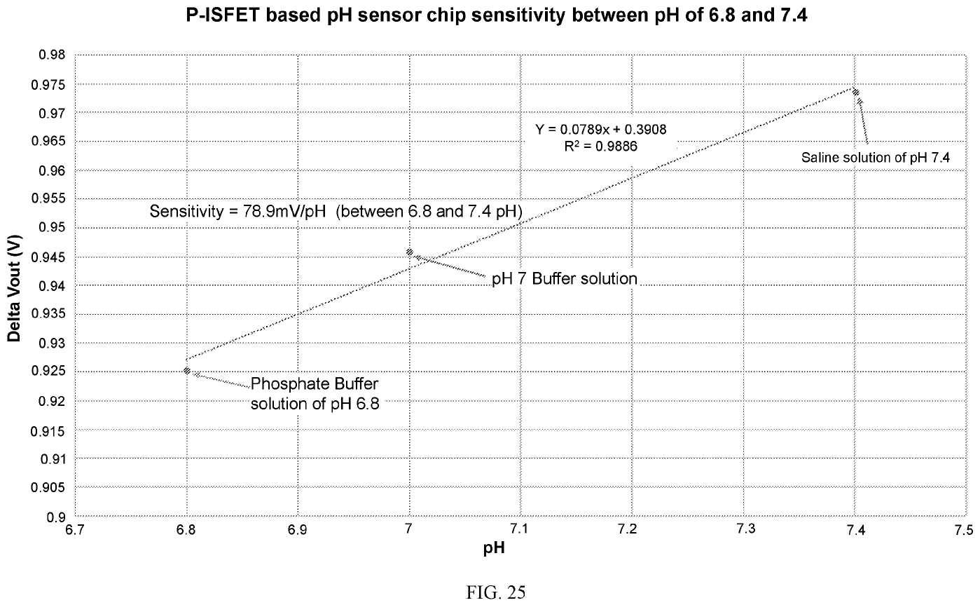

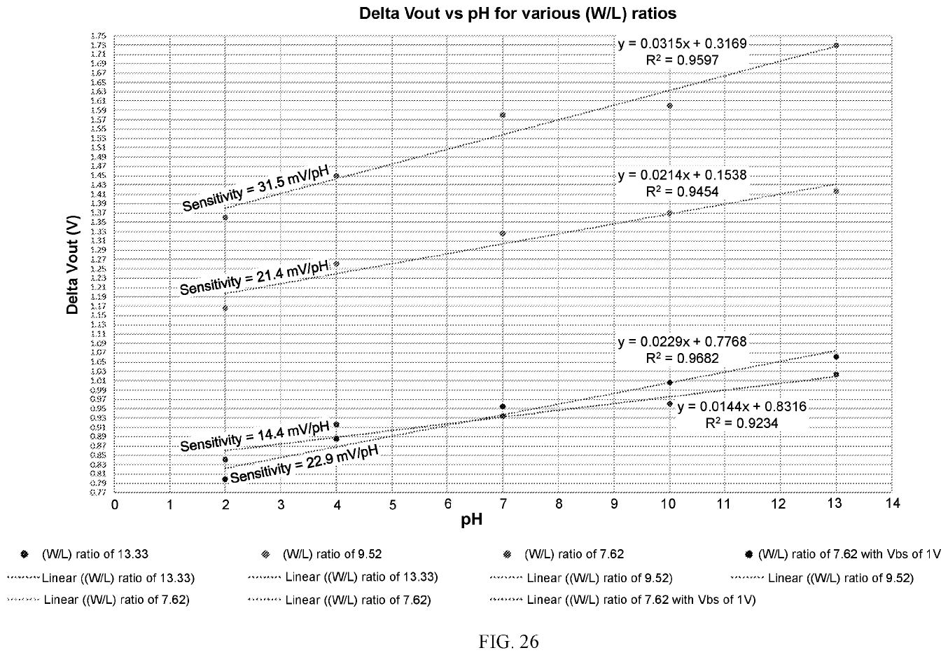

FIGS. 25-26 show results from testing the P-ISFET chip-based pH sensor using corrosive liquids such as saline solution.

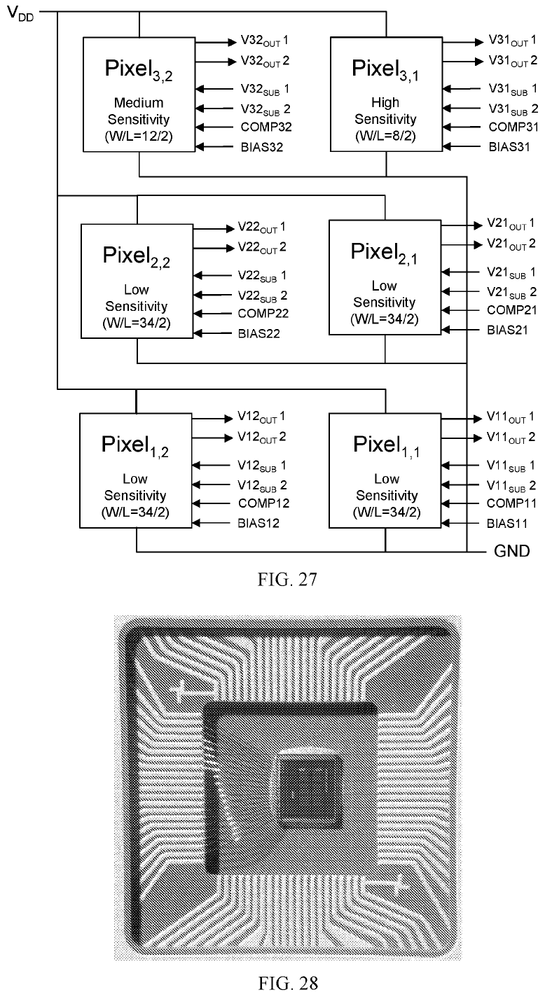

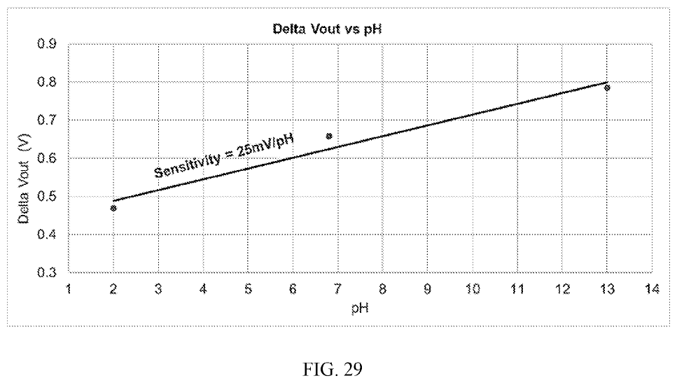

In another embodiment of the present disclosure, a P-ISFET sensor chip may be implemented as an array of P-ISFETs—a “Pixel Array Chip.” FIG. 27 shows a schematic of a non-limiting example of an implementation of P-ISFET based Pixel Array Chip. A plurality of P-ISFETS are arranged in an array form wherein each P-ISFET may form a pixel. The pixel array may include a plurality of pairs of P-ISFET sensors. In the non-limiting, example pixel array of FIG. 27, four of the pixels (designated 1,1; 1,2; 2,1; and 2,2) are configured to have a small load size (W/L) of 34 μm/2 μm (“normal” sensitivity), pixel 3,2 has small load size (W/L) of 12 μm/2 μm (“medium” sensitivity), and pixel 3,1 has small load size (W/L) of 8 μm/2 μm (“high” sensitivity). The sensitivities described are relative to one another. FIG. 28 demonstrates a microscopic image of the P-ISFET based Pixel Array Chip wire bonded to a PGA Package. FIG. 29 demonstrates that the P-ISFET based Pixel Array Chip responds to change in pH values with a sensitivity of around 25 mV/pH.

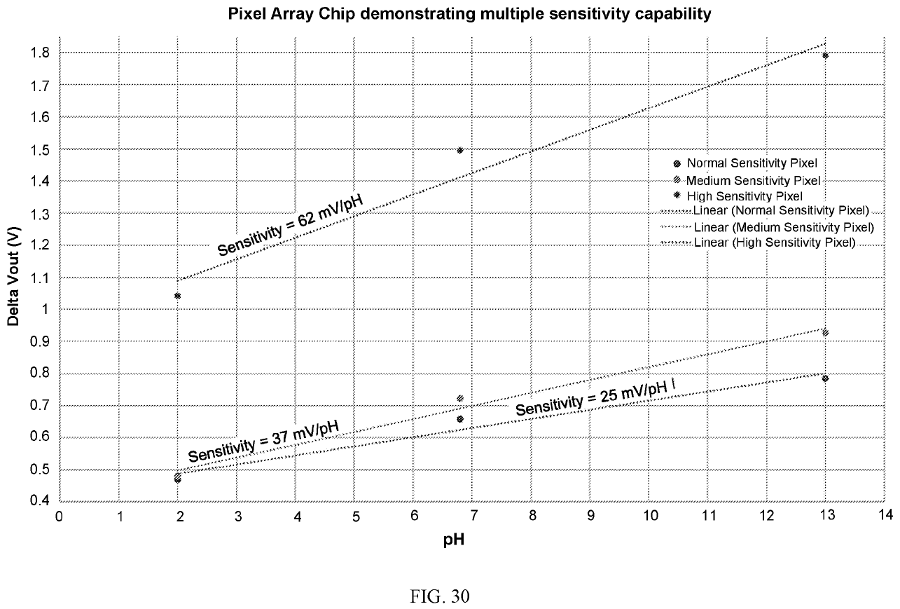

In another embodiment of the present disclosure, the P-ISFET based Pixel Array is configured to provide multiple sensitivity. As a non-limiting example, each pixel can be operated at a different sensitivities by appropriately selecting the width of the small load NMOS. As a non-limiting example, it was observed that small load NMOS channel widths of 34 μm, 12 μm, and 8 μm provided lower sensitivity, medium sensitivity, and higher sensitivity, respectively. This is shown in FIG. 30.

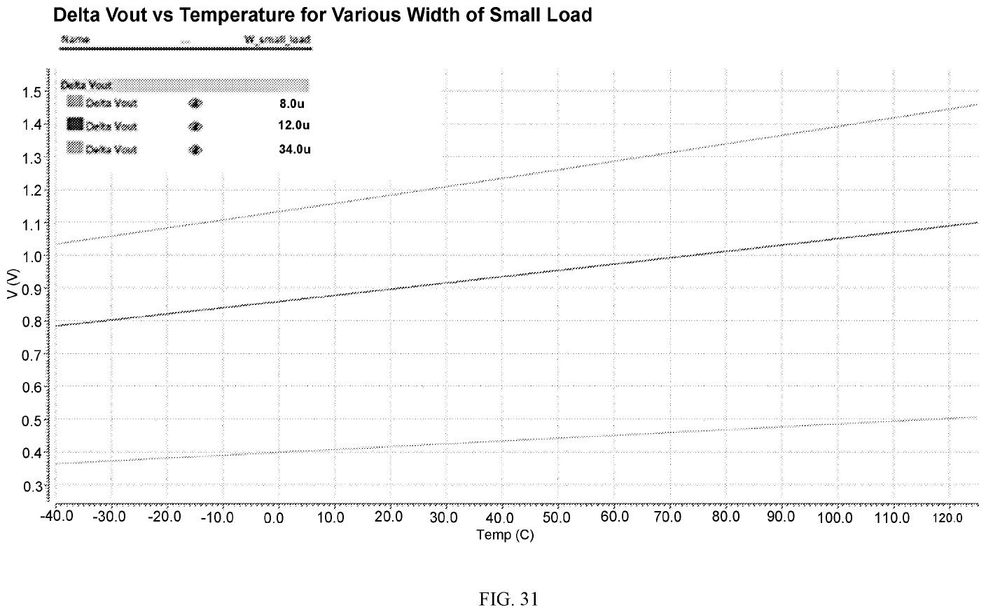

In some embodiments of the present disclosure, the P-ISFET based Pixel Array may be configured to reject common-mode non-idealities such as temperature effects, drift, and chemical and electrical noise. As a non-limiting example, a higher width of small load NMOS transistor may be selected to achieve a low sensitivity, higher non-ideality rejection mode. This approach eliminates complex software or hardware compensation schemes for temperature, drift and offset elimination. Higher sensitivity mode can be availed at the expense of lower non-ideality rejection and higher non-ideality rejection mode can be chosen at the expense of lower sensitivity. FIG. 31 shows Delta Vout vs Temperature for Normal, Medium, and Higher Sensitivity Pixels, as described above, of P-ISFET based Pixel Array Chip demonstrating better temperature (non-ideality) rejection at higher width of small load at the expense of better sensitivity.

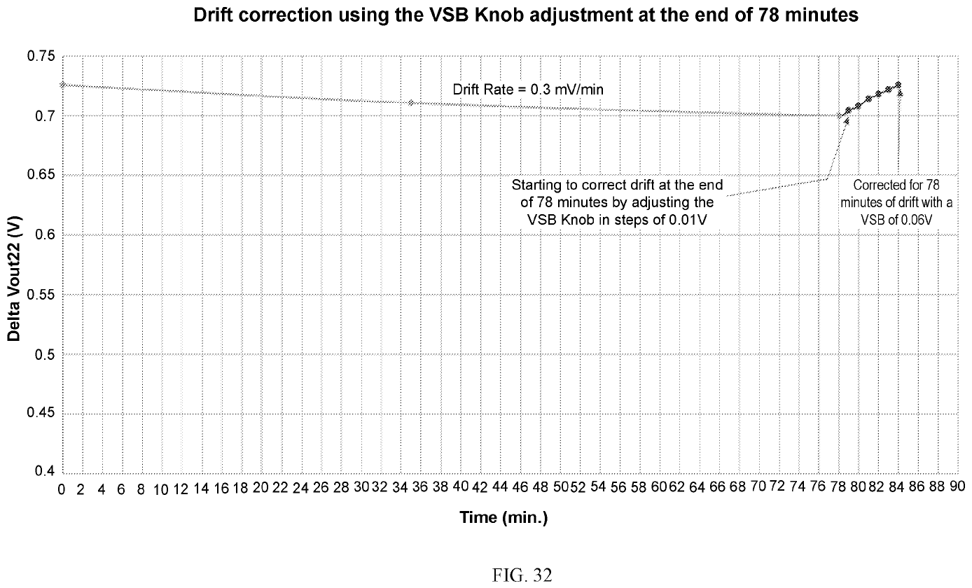

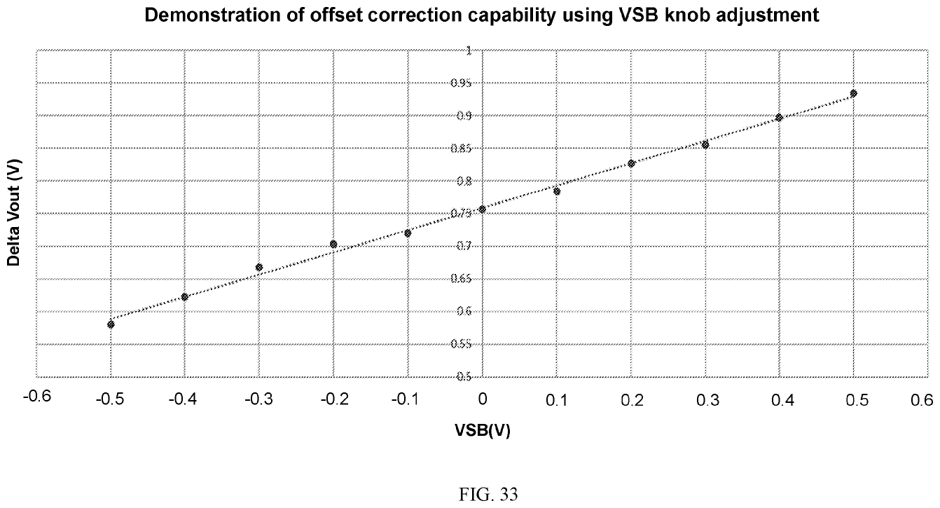

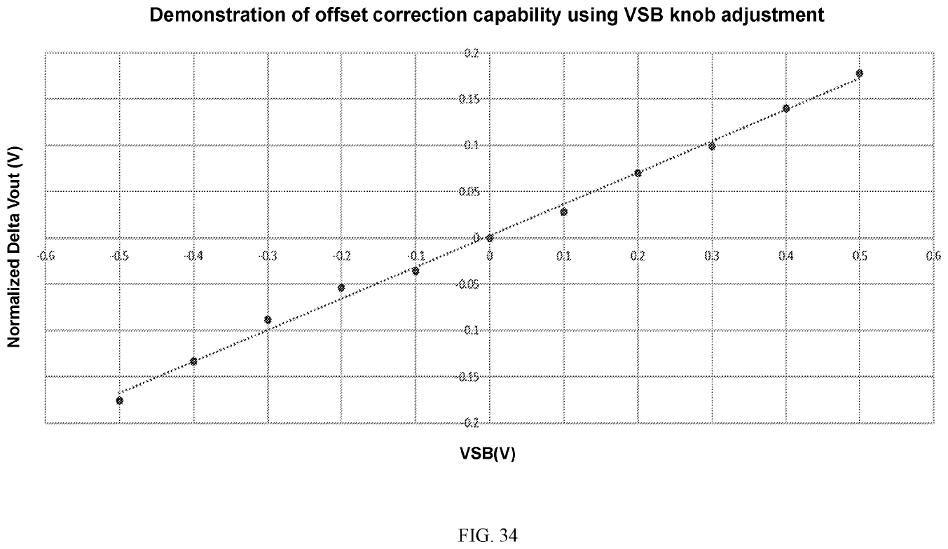

FIG. 32 shows a drift of P-ISFET based Pixel Array Chip (0.3 m V/min) and the successful application of substrate control voltage knob (V_{SB}=0.06 V) to nullify drift. FIG. 33 shows the approximate range through which output voltage of the P-ISFET based Pixel Array Chip could be adjusted to counter offset and drift using the substrate control voltage (V_{SB}) adjustment knob. FIG. 34 shows the normalized variation in output voltage in response to V_{SB} knob adjustment clearly demonstrating that up to 0.4 V of offset/drift could be corrected easily with this design.

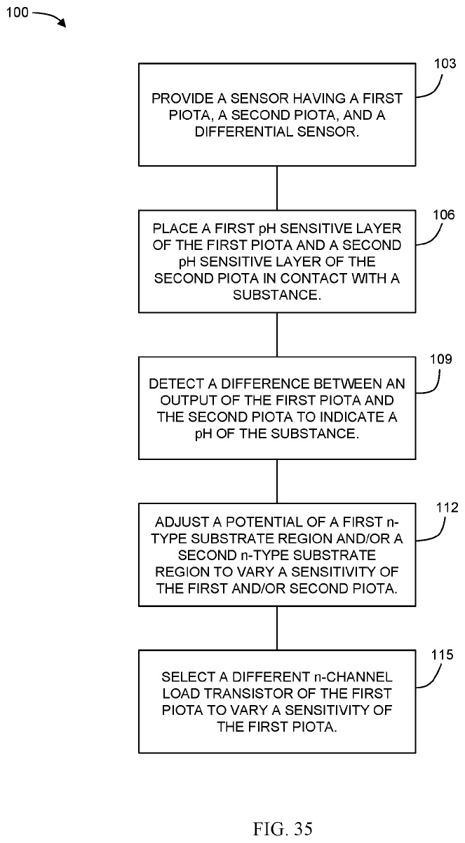

In another embodiment of the present disclosure, a method of sensing a pH is provided. FIG. 35 is a flow diagram showing steps according to one such method. As an example of a method 100 according to the disclosure, a sensor may be provided 103. The provided sensor may have:
(a) a first ion-sensitive-transistor-operational-transconductance-amplifier (the “first PIOTA”) having p-channel ion-sensitive transistor (the “first p-channel IST”). The first p-channel IST is disposed in an n-type substrate region (the “first n-type substrate region”). The first p-channel IST is electrically connected to an n-channel load transistor (the “first n-channel load transistor”), and also having an output (the “first PIOTA output”), the first p-channel IST having a pH sensitive layer (the “first pH sensitive layer”);
(b) a second ion-sensitive-transistor-operational-transconductance-amplifier (the “second PIOTA”) having a p-channel ion-sensitive transistor (the “second p-channel IST”). The second p-channel IST is disposed in an n-type substrate region (the “second n-type substrate region”). The second p-channel IST is electrically connected to an n-channel load transistor (the “second n-channel load transistor”), and also having an output (the “second PIOTA output”), the second p-channel IST having a pH sensitive layer (the “second pH sensitive layer”), wherein the first n-channel load transistor provides a drain-to-source resistance (the “first R_{ds}”) in the first PIOTA, and the second n-channel load transistor provides a drain-to-source resistance (the “second R_{ds}”) in the second PIOTA, and the first R_{ds} is different from the second R_{ds}, and
(c) a differential sensor having a first input, a second input, and an output (the “differential sensor output”), wherein the first input is in communication with the first PIOTA output, wherein the second input is in communication with the second PIOTA output, and wherein the differential sensor output may be used to provide an indication of a voltage difference between the first input and the second input.

The first pH sensitive layer and the second pH sensitive layer may be placed 106 in contact with a substance. For example, the substance may be the blood or saliva of a person on whom a medical procedure is being performed. The first PIOTA and the second PIOTA produces different outputs in response to a pH of the substance. The differential sensor then detects 109 the difference between the PIOTA outputs, and said difference indicates the pH of the substance. The differential sensor further enhances sensitivity by eliminating fluctuations of pH values due to non-idealities such as temperature. The method 100 includes adjusting 112 a potential of the first n-type substrate region and/or the second n-type substrate region (V_{BS}) to vary the sensitivity of the first PIOTA and/or the second PIOTA, respectively.

The first PIOTA may have one or more additional n-channel load transistors, each having an R_{ds} which is different from the R_{ds} of the other n-channel load transistors (i.e., the first n-channel load transistor, the second n-channel load transistor, and the other additional n-channel load transistors). The method 100 may further comprise selecting 115 a different n-channel load transistor from the one or more additional n-channel load transistors or a combination thereof to adjust a sensitivity of the first PIOTA.

It should be noted that certain embodiments were described based on 5 V CMOS technology solely for convenience, and the present disclosure is intended to include other CMOS technologies (such as, for example, 3.3 V levels, etc.)

Although the present disclosure has been described with respect to one or more particular embodiments, it will be understood that other embodiments of the present disclosure may be made without departing from the spirit and scope of the present disclosure.

What is claimed is:

1. A differential pH sensor, comprising:
a first ion-sensitive transistor (IST)-operational-transconductance-amplifier (PIOTA) comprising:
a first p-channel IST disposed in a first n-type substrate region having a terminal configured to receive a first control voltage for controlling a sensitivity of the first p-channel IST; and
a first n-channel load transistor having a source and a drain, wherein the first n-channel load transistor has a first drain-to-source resistance (R_{ds}), and wherein the drain of the first n-channel load resistor is electrically connected to a drain of the first p-channel IST;
a second PIOTA comprising:
a second p-channel IST disposed in a second n-type substrate region having a terminal configured to receive a second control voltage for controlling a sensitivity of the second p-channel IST; and
a second n-channel load transistor having a source and a drain, and wherein the second n-channel load transistor has a second R_{ds} which is different from the first R_{ds}, and wherein the drain of the second n-channel load resistor is electrically connected to a drain of the second p-channel IST;
a differential sensor having a differential sensor output configured to provide a voltage indicative of a difference in potential between an output of the first PIOTA and an output of the second PIOTA.

2. The sensor of claim 1, wherein one or more additional n-type substrate regions corresponding to one or more additional p-channel ISTs and the potential of each n-type substrate region is varied independently.

3. The sensor of claim 2, wherein the one or more additional n-type substrate regions are configured in a common p-type substrate.

4. The sensor of claim 1, wherein the first PIOTA, the second PIOTA, or both further comprises a plurality of selectable n-channel transistors with different R_{ds} from which at least one of the first and second n-channel load transistors may be selected respectively.

5. The sensor of claim 1, wherein the first PIOTA further comprises an amplifier wherein the input of the amplifier is electrically connected to the drain of the first p-channel IST and drain of the first n-channel load transistor, and wherein an output of the amplifier is the first PIOTA output.

6. The sensor of claim 1, wherein the second PIOTA further comprises an amplifier wherein the input of the amplifier is electrically connected to the drain of the second p-channel IST and the drain of the second n-channel load transistor, and wherein an output of the amplifier is the second PIOTA output.

7. The sensor of claim 1, wherein the first PIOTA output is electrically connected to the gate of first n-channel load transistor, and the second PIOTA output is electrically connected to the gate of the second n-channel load transistor, in each case to control the R_{ds} of the respective n-channel load transistor.

8. A p-channel ion-sensitive transistor (IST)-operational-transconductance-amplifier (PIOTA) having adjustable sensitivity, comprising:
a p-channel IST disposed in an n-type substrate, wherein the n-type substrate has a terminal configured to receive a control voltage for controlling a sensitivity of the p-channel IST; and
an n-channel load transistor having a source and a drain, wherein the n-channel load transistor has a drain-to-source resistance (R_{ds}), and wherein the drain of the n-channel load resistor is electrically connected to a drain of the first p-channel IST; and
an amplifier wherein the input of the amplifier is electrically connected to the drain of the p-channel IST and the drain of the first n-channel load transistor, and having an output configured to provide a voltage which varies based on a pH of a sample.

9. The PIOTA of claim 8, further comprising a plurality of selectable n-channel transistors, each having a different R_{ds} from each other, and each selectable, alone or in combinations, as the load of the PIOTA.

10. A pH sensing method, comprising:
providing a sensor having:
a first ion-sensitive-transistor (IST)-operational-transconductance-amplifier (PIOTA) comprising:
a first pH sensitive layer;
a first PIOTA output;
a first p-channel IST with a drain, and wherein the first p-channel IST is disposed in a first n-type substrate region; and
a first n-channel load transistor including a source, a drain, and a channel, the channel electrically connecting the source and the drain, and wherein the first n-channel load transistor includes a first drain-to-source resistance (R_{ds});
wherein the drain of the first p-channel IST is electrically connected to the drain of the first n-channel load transistor;
a second PIOTA comprising:
a second pH sensitive layer;
a second PIOTA output;
a second p-channel IST with a drain, and wherein the second p-channel IST is disposed in a second n-type substrate region; and
a second n-channel load transistor including a source, a drain and a channel, the channel electrically connecting the source and the drain, and wherein the second n-channel load transistor includes a second R_{ds}, and the second R_{ds} is different from the first R_{ds};
wherein the drain of the second p-channel IST is electrically connected to the drain of the second n-channel load transistor;
a differential sensor comprising:
a first input connected to the first PIOTA output;
a second input connected to the second PIOTA output; and
a differential sensor output wherein the differential sensor output may be configured to provide an indication of a voltage difference between the first input and the second input;
placing the first pH sensitive layer and the second pH sensitive layer in contact with a substance;
detecting a difference between first PIOTA output and second PIOTA output, and providing the difference to indicate a pH of the substance; and
adjusting the potentials of at least one of the first and second n-type substrate regions to vary the sensitivity of at least one of the first PIOTA and second PIOTA, respectively.

11. The method of claim 10, wherein the first PIOTA has one or more additional n-channel load transistors, each having an R_{ds} which is different from the R_{ds} of the other n-channel load transistors, and the method further comprising selecting a different n-channel load transistor to adjust a sensitivity of the first PIOTA.

12. A pH sensor integrated circuit (“IC” or “chip”), comprising:
a first ion-sensitive transistor (IST)-operational-transconductance-amplifier (PIOTA) comprising:
a first p-channel IST with a drain region, wherein the first p-channel IST is disposed in a first n-type substrate region having a first terminal configured to receive a first control voltage for controlling a sensitivity of the first p-channel IST; and
a first n-channel load transistor including a source region, a drain region, and a channel region, the channel region electrically connecting the source region and the drain region, and wherein the first n-channel load transistor has a first drain-to-source resistance (R_{ds});
wherein the drain region of the first p-channel IST is electrically connected to the drain region of the first n-channel load transistor;
a second PIOTA comprising:
a second p-channel IST with a drain region, wherein the second p-channel IST is disposed in a second n-type substrate region having a second terminal configured to receive a second control voltage for controlling a sensitivity of the second p-channel IST; and
a second n-channel load transistor including a source region, a drain region and a channel region, the channel region electrically connecting the source region and the drain region, and wherein the second n-channel load transistor has a second R_{ds} which is different from the first R_{ds};
wherein the drain region of the second p-channel IST is electrically connected to the drain region of the second n-channel load transistor;
a differential sensor comprising:
a first input connected to an output of the first PIOTA;
a second input connected to an output of the second PIOTA; and
a differential sensor output configured to provide a voltage indicative of a difference in potential between the first input and the second input.

13. The IC of claim 12, wherein a plurality of n-wells corresponding to a plurality of p-channel ISTs are configured in a common p-type substrate and the potential of each n-well is varied independently.

14. The IC of claim 12, wherein at least one of the first and second PIOTA further comprises a plurality of selectable n-channel transistors with different Width/Length (W/L) ratio from which the first and second n-channel load transistors respectively may be selected, where W is a width of the channel region of the n-channel transistor and L is the length of the channel region of the n-channel transistor.

15. The IC of claim 12, wherein the first PIOTA output and the second PIOTA output are electrically connected to the gate region of first n-channel load transistor and the second n-channel load transistor respectively to control the R_{ds} of the respective n-channel load transistors.

16. The IC of claim 12, wherein the first PIOTA, the second PIOTA, and the differential sensor make up a pixel, and the IC comprises a plurality of such pixels.

17. The IC of claim 16, wherein the plurality of pixels are arranged as an array.

18. The IC of claim 16, wherein each pixel of the plurality of pixels is configured to have a sensitivity different from a sensitivity of at least one of the other pixels of the plurality of pixels.

19. The IC of claim 16, wherein each pixel of the plurality of pixels is configured to be operable in a non-ideality rejection mode different from a non-ideality rejection mode of at least one of the other pixels of the plurality of pixels.
